(19) United States
(12) Patent Application Publication
(10) Pub. No.: US 2011/0172792 A1
(43) Pub. Date: Jul. 14, 2011

(54) ENERGY MANAGEMENT SYSTEM AND COMPUTER PROGRAM PRODUCT

(76) Inventors: Kiyotoshi Shinohara, Kyoto (JP); Akio Nakano, Osaka (JP); Masaaki Terano, Nara (JP); Tooru Shimotsuma, Osaka (JP); Ryuichi Maeda, Osaka (JP); Tomoya Sogou, Osaka (JP)

(21) Appl. No.: 12/997,085

(22) PCT Filed: Jun. 10, 2009
(86) PCT No.: PCT/JP2009/060621

§ 371 Date: Jan. 4, 2011

(30) Foreign Application Priority Data
Jun. 10, 2008 (JP) 2008-152092

(51) Int. Cl. G06F 19/00; G06G 7/62

(52) U.S. Cl. 700/90; 703/13; 703/2

(57) ABSTRACT

The energy management system includes a judging means (103), a usage information means (105), a schedule input means (106), a simulating means (108), a prediction information indicating means (110). The judging means (103) judges whether or not the device was used for each unit time, on the basis of power consumption of the device in a predetermined time period (measurement value). The usage information indicating means (105) indicates whether or not the device was used for each unit time, on the basis of the judgment result of the judging means (103). The schedule input means (106) requires a user to input schedule information which defines operation of the device for each unit time in the predetermined time period. The simulating means (108) calculates power consumption (prediction value) used in the device which operates in accordance with the schedule information input via the schedule input means (106), on the basis of the measurement value. The prediction information indicating means (110) indicates the prediction value calculated by the simulating means (108).

### TECHNICAL FIELD

The present invention is directed to an energy management system and a computer program product.

### BACKGROUND ART

In the past, as disclosed in Japanese patent laid-open publication No. 8-5051, there is an energy management system (EMS).

The above energy management system is configured to collect a data of power usage of an electric device installed in a building or an establishment, and a data of such as environmental information (e.g., temperature, and humidity) and control-information of each electric device. Further, the energy management system is configured to assemble the collected data for each a predetermined time period (e.g., a day, a month, and a year), and then indicate power consumption by use of a graph (e.g., line graph and bar graph).

The aforementioned energy management system is configured to control the electric device in accordance with schedule information which defines operation of the electric device. Therefore, in order to reduce power consumption of the electric device, the schedule should be adjusted reasonably.

However, the aforementioned energy management system only indicates collected power consumption in a graph.

Therefore, only a manager, who is skilled in an energy management technique and has enough knowledge, can calculate how much power consumption is reduced when the schedule information is changed.

### DISCLOSURE OF INVENTION

In view of the above insufficiency, the present invention has been aimed to propose an energy management system and a computer program product which are capable of preparing schedule information for reducing usage of energy resources.

The energy management system in accordance with the present invention is an energy management system for managing a device, and includes an obtaining means, a measurement value storing means, a judging means, a judgment storing means, a usage information indicating means, a schedule input means, a schedule storing means, a simulating means, a prediction value storing means, and a prediction information indicating means. The obtaining means is configured to obtain a measurement value indicative of an amount of measured energy resources used in the device in a predetermined time period. The measurement value storing means is configured to store the measurement value obtained by the obtaining means. The judging means is configured to judge whether or not the device was used for each unit time, on the basis of the measurement value stored in the measurement value storing means. The judgment storing means is configured to store a judgment result indicative of a result obtained by judgment of the judging means. The usage information indicating means is configured to indicate whether or not the device was used for each unit time, on the basis of the judgment result stored in the judgment storing means. The schedule input means is adapted in use to input schedule information which defines operation of the device for each unit time in the predetermined time period. The schedule storing means is configured to store the schedule information input by use of the schedule input means. The simulating means is configured to calculate a prediction value on the basis of the measurement value stored in the measurement value storing means, the prediction value being indicative of the energy resources used in the device which operates in accordance with the schedule information stored in the schedule storing means. The prediction value storing means is configured to store the prediction value calculated by the simulating means. The prediction information indicating means is configured to indicate the prediction value stored in the prediction value storing means.

According to the present invention, a user can know whether or not the device was used per each unit time. Therefore, the user can input the schedule information with consideration for whether the device was used. When the schedule information is input, the energy management system indicates usage of the energy resources obtained when the device operates in accordance with the input schedule information. Therefore, the user can easily know an amount of the energy resources which the modified schedule information can save. Thus, it is easy to create the schedule information for reducing the usage of the energy resources, in conformity with usage pattern of the device.

In a preferred embodiment, the energy management system includes an evaluating means, an evaluation storing means, and an evaluation indicating means. The evaluating means is configured to evaluate, on the basis of the measurement value stored in the measurement value storing means and the schedule information stored in the schedule storing means, whether use of the device is reasonable or wasteful for each unit time. The evaluation storing means is configured to store an evaluation result indicative of a result obtained by evaluation of the evaluating means. The evaluation indicating means is configured to indicate, on the basis of the evaluation result stored in the evaluation storing means, whether the use of the device is reasonable or wasteful for each unit time.

With this embodiment, a user can easily know whether use of the device is reasonable or wasteful, and can appropriately modify the schedule information.

In a preferred embodiment, the evaluating means is configured to, when a variation with time of the measurement value stored in the measurement value storing means fulfills a prescribed condition, determine that the use of the device is wasteful.

More preferably, the prescribed condition is defined as a condition where a period in which the measurement value exceeds a predetermined threshold is kept over a predetermined time.

With this embodiment, it can be easy to judge whether use of the device is reasonable or wasteful.

In a preferred embodiment, the energy management system includes a device information storing means configured to store, for each device, a type of the device and a installation site indicative of a place in which the device is installed. The evaluating means is configured to judge, on the basis of the type and the installation site for each device stored in the device information storing means, whether or not a plurality of the devices having different types exist on the same installation site. The evaluating means is configured to, upon determining the plurality of the devices having different types exist on the same installation site, evaluate, on the basis of a combination of the type of each device and the judgment result, whether use of the device is reasonable or wasteful.

With this embodiment, it is possible to successfully judge whether use of the device is reasonable or wasteful.

In a preferred embodiment, the evaluating means is configured to, when a particular time fulfils a predetermined exception condition, determine that use of the device in the particular time is reasonable, the particular time being defined as time in which it is determined that use of the device is wasteful.

With this embodiment, it is possible to more precisely judge whether use of the device is reasonable or wasteful.

In a preferred embodiment, the energy management system includes an information storing means configured to store, for each device, an installation site indicative of a place in which the device is installed, and a human detecting means configured to detect human presence in the installation site. The exception condition is defined as a condition where the human detecting means has detected a human presence in the installation site of the device.

With this embodiment, when a human exists in the installation site of the device, it is determined that use of the device is not wasteful. Therefore, it is possible to make evaluation in line with the current condition.

In a preferred embodiment, the usage information indicating means is configured to indicate numerically the energy resources used in the device.

With this embodiment, a user can know, in more detail, power consumption of the electric device in accordance with the schedule information.

In a preferred embodiment, the energy management system includes a control device configured to control the device, and a configuration device configured to communicate with the control device. The control device includes a configuration storing means, a device control means, a schedule receiving means, and a rescheduling means. The configuration storing means is configured to store the schedule information. The device control means is configured to control the device in conformity with the schedule information stored in the configuration storing means. The schedule receiving means is configured to receive the schedule information from the configuration device. The rescheduling means is configured to change contents of the schedule information stored in the configuration storing means into contents of the schedule information received at the schedule receiving means. The configuration device includes a determining means, a current schedule storing means, a checking means, a check storing means, and a schedule sending means. The determining means is adapted in use to determine change of the schedule information stored in the configuration storing means of the control device. The current schedule storing means is configured to store the schedule information stored in the configuration storing means. The checking means is configured to check, on the basis of the schedule information stored in the schedule storing means and the schedule information stored in the current schedule storing means, whether or not the schedule information has been changed. The check storing means is configured to store a check result indicative of a result obtained by check of the checking means. The schedule sending means is configured to, when the modification of the schedule information stored in the configuration storing means is determined by use of the determining means, send only modified schedule information to the control device with reference to the check result stored in the check storing means.

With this embodiment, a user can incorporate modification of the schedule information.

In a preferred embodiment, the energy management system includes plural measurement devices, a monitoring device configured to communicate with the plural measurement devices respectively, and a terminal device configured to communicate with the monitoring device. The terminal device includes the obtaining means, the measurement value storing means, the judging means, the judgment storing means, the usage information indicating means, the schedule input means, the schedule information storing means, the simulating means, the prediction value storing means, and the prediction information indicating means. Each of the measurement devices includes a measuring means configured to measure an amount of energy resources used in the device in the predetermined time period, thereby obtaining the measurement value, and a first storing means configured to store the measurement value obtained by the measuring means. The monitoring device includes a measurement value obtaining means configured to retrieve the measurement value from the first storing means of each of the measurement device, and a second storing means configured to store the measurement value retrieved by the measurement value obtaining means. The obtaining means is configured to acquire the measurement value from the second storing means of the monitoring device.

The program product in accordance with the present invention is a program product used in an energy management system managing devices. When a computer executes the program product, the computer functions as an obtaining means, a judging means, a judgment storing means, a usage information indicating means, a schedule input means, a schedule storing means, a simulating means, a prediction value storing means, and a prediction information indicating means. The obtaining means is configured to obtain a measurement value indicative of an amount of measured energy resources used in the device in a predetermined time period. The measurement value storing means is configured to store the measurement value obtained by the obtaining means. The judging means is configured to judge whether or not the device is used for each unit time, on the basis of the measurement value stored in the measurement value storing means. The judgment storing means is configured to store a judgment result indicative of a result obtained by judgment of the judging means. The usage information indicating means is configured to indicate whether or not the device is used for each unit time. The schedule input means is adapted in use to input schedule information which defines operation of the device for each unit time in the predetermined time period. The schedule storing means is configured to store the schedule information input by use of the schedule input means. The simulating means is configured to calculate a prediction value on the basis of the measurement value stored in the measurement value storing means, the prediction value indicative of the energy resources used in the device which operates in accordance with the schedule information stored in the schedule storing means. The prediction value storing means is configured to store the prediction value calculated by the simulating means. The prediction information indicating means is configured to indicate the prediction value stored in the prediction value storing means.

According to the present invention, a user can know whether or not the device was used per each unit time. Therefore, the user can input the schedule information with consideration for whether the device was used. When the schedule information is input, the energy management system indicates usage of the energy resources obtained when the device operates in accordance with the input schedule information. Therefore, the user can easily know an amount of the energy resources which the modified schedule information can save. Thus, it is easy to create the schedule information for reducing the usage of the energy resources, in conformity with usage pattern of the device.

### BRIEF DESCRIPTION OF DRAWINGS

FIG. 1 is a block diagram illustrating a terminal device of an energy management system of one embodiment in accordance with the present invention,

FIG. 2 is a schematic configuration diagram illustrating the above energy management system,

FIG. 3A is a block diagram illustrating a control device of the above energy management system,

FIG. 3B is a block diagram illustrating a control device of the above energy management system,

FIG. 4 is a schematic diagram illustrating a central monitoring board of the above energy management system,

FIG. 5 is a schematic diagram illustrating the terminal device of the above energy management system,

FIG. 6 is a flowchart explaining operation of the above energy management system,

FIG. 7 is an explanatory view illustrating an initial screen displayed on the terminal device of the above energy management system,

FIG. 8 is an explanatory view illustrating a configuration screen displayed on the terminal device of the above energy management system,

FIG. 9 is an explanatory view illustrating the configuration screen displayed on the terminal device of the above energy management system,

FIG. 10 is an explanatory view illustrating a screen displayed on the terminal device of the above energy management system,

FIG. 11 is an explanatory view illustrating a screen displayed on the terminal device of the above energy management system,

FIG. 12 is an explanatory view illustrating a screen displayed on the terminal device of the above energy management system,

FIG. 13 is an explanatory diagram illustrating measurement data of power consumption retrieved by the terminal device of the above energy management system,

FIG. 14 is an explanatory view illustrating the configuration screen displayed on the terminal device of the above energy management system,

FIG. 15 is an explanatory view illustrating a simulation screen displayed on the terminal device of the above energy management system,

FIG. 16 is an explanatory view illustrating the simulation screen displayed on the terminal device of the above energy management system,

FIG. 17 is an explanatory view illustrating the simulation screen displayed on the terminal device of the above energy management system,

FIG. 18 is an explanatory view illustrating the simulation screen displayed on the terminal device of the above energy management system,

FIG. 19 is an explanatory view illustrating the simulation screen displayed on the terminal device of the above energy management system,

FIG. 20 is an explanatory view illustrating the simulation screen displayed on the terminal device of the above energy management system,

FIG. 21 is an explanatory view illustrating the simulation screen displayed on the terminal device of the above energy management system,

FIG. 22 is an explanatory view illustrating the simulation screen displayed on the terminal device of the above energy management system,

FIG. 23 is an explanatory view illustrating the simulation screen displayed on the terminal device of the above energy management system,

FIG. 24 is an explanatory view illustrating the simulation screen displayed on the terminal device of the above energy management system,

FIG. 25 is an explanatory view illustrating the simulation screen displayed on the terminal device of the above energy management system,

FIG. 26 is an explanatory view illustrating the simulation screen displayed on the terminal device of the above energy management system,

FIG. 27 is an explanatory view illustrating a judging logic of the terminal device of the above energy management system, and

FIG. 28 is a schematic configuration diagram illustrating a modification of the above energy management system.

### BEST MODE FOR CARRYING OUT THE INVENTION

An energy management system of one embodiment in accordance with the present invention is adapted in use to manage devices installed in a building (e.g., tenant building) B. The devices managed by the energy management system of the present embodiment are defined to operate in conformity with after-mentioned schedule information. The devices are lighting fixtures L1 to L4 and air conditioners AC1 to AC4, for example.

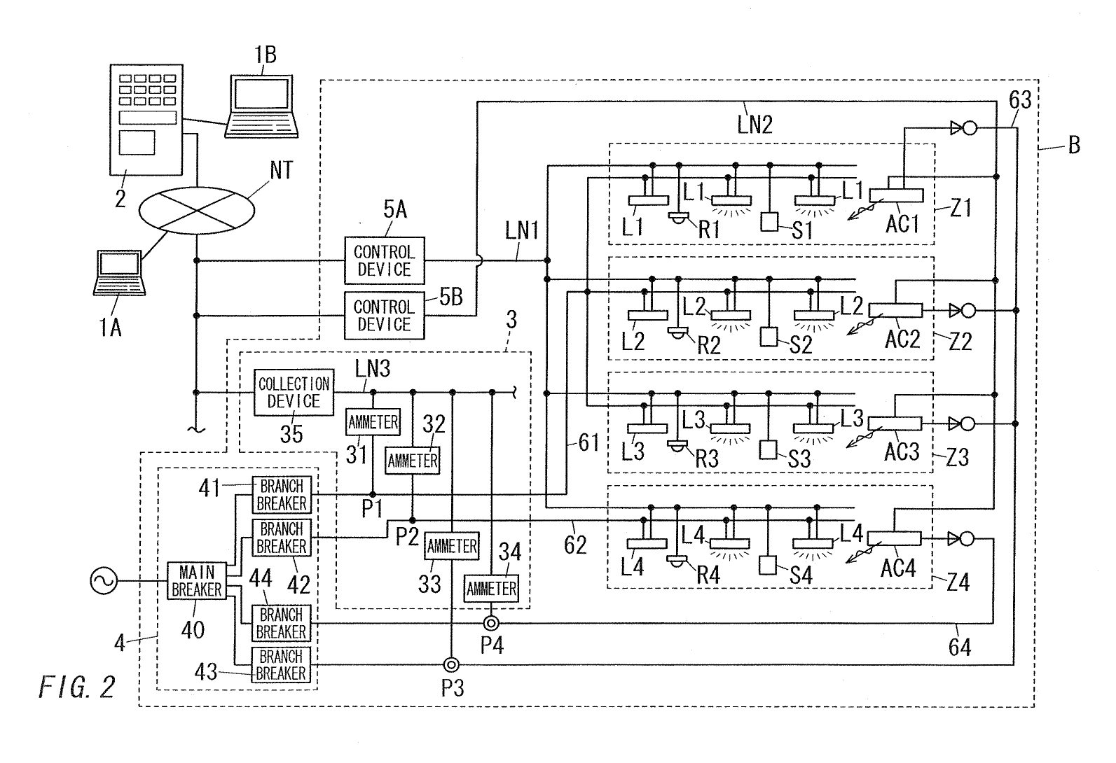

As shown in FIG. 2, the energy management system of the present embodiment includes terminal devices 1A and 1B, a monitoring device (central monitoring board) 2, a measurement device 3, and control devices 5A and 5B. The monitoring device 2 is connected to the measurement device 3 and the control devices 5A and 5B via a communication network NT such as Internet. In addition, global IP addresses are assigned to each of the measurement device 3 and the control devices 5A and 5B. The measurement device 3 and the control devices 5A and 5B have a function of communicating with each other via the communication network NT. Further, the terminal device 1A is connected to the monitoring device 2 via the communication network NT. The terminal device 1B is connected to the monitoring device 2 via a LAN.

The building B is two-story, for example. Four zones (installation sites) Z1 to Z4 are assigned to the building B. The three zones Z1 to Z3 are assigned to the first floor of the building B, and the first floor of the building B is partitioned into three sites. The zone Z4 is assigned to the entire second floor of the building B.

The lighting fixtures L1 to L4, the air conditioners AC1 to AC4, manipulation switches (lighting switches) S1 to S4 for lighting, manipulation switches (air conditioning switches) for air conditioning not shown, and human sensors (human detecting means) R1 to R4 are installed in the zones Z1 to Z4, respectively.

The lighting fixtures L1 to L4, the lighting switches S1 to S4, and the human sensors R1 to R4 in each of the zones Z1 to Z4 are connected to the control device 5A by use of a transmission line LN1. Unique address information is assigned to each of the lighting fixtures L1 to L4, the lighting switches S1 to S4, and the human sensors R1 to R4.

The lighting switches S1 to S4 are used for making control (e.g., on-off control) of the lighting fixtures L1 to L4 installed in the same zones Z1 to Z4, respectively. Each of the lighting switches S1 to S4 is configured to send an operation signal (lighting operation signal) corresponding to manipulation of a user to the control device 5A.

The air conditioning switches are used for making control (e.g., on-off control) of the air conditioners AC1 to AC4 installed in the same zones, respectively. Each of the air conditioning switches is configured to send an operation signal (air conditioning operation signal) corresponding to manipulation of a user to the control device 5B.

The human sensors R1 to R4 are configured to detect human presence in the same zones Z1 to Z4, respectively. The human sensors R1 to R4 are configured to send a detection signal (human detection signal) to the control device 5A upon detecting human presence in the corresponding zones Z1 to Z4, respectively.

The air conditioners AC1 to AC4 are connected to the control device 5B by use of a transmission line LN2. Unique address information is assigned to each of the air conditioners AC1 to AC4.

In addition, there is a distribution board 4 installed inside of the building B. The distribution board 4 incorporates a main breaker 40, a plurality of branch breakers 41 to 44. The lighting fixtures L1 to L3 in each of the zones Z1 to Z3 are connected to a branch circuit 61 corresponding to the branch breaker 41. The lighting fixture L4 in the zone Z4 is connected to a branch circuit 62 corresponding to the branch breaker 42. The air conditioners AC1 to AC3 in each of the zones Z1 to Z3 are connected to a branch circuit 63 corresponding to the branch breaker 43. The air conditioner AC4 in the zone Z4 is connected to a branch circuit 64 corresponding to the branch breaker 44. The branch circuits 61 to 64 are provided with measurement points P1 to P4 for measuring a load current, respectively.

The measurement device 3 is configured to measure power consumption of the devices, such as the lighting fixtures L1 to L4, and the air conditioners AC1 to AC4, and send the measured power consumption to both the monitoring device 2 and the terminal device 1A. The measurement device 3 is defined as a consumed power measuring means configured to measure power consumption of an electrical device.

The measurement device 3 includes power meters 31 to 34 installed inside of the building B and a collection device (power monitoring device) 35.

Each of the power meters 31 to 34 is connected to the collection device 35 by use of a signal line LN3. The power meters 31 to 34 measure load currents corresponding to the measurement points P1 to P4 (that is, power consumption in the branch circuits 61 to 64) at a predetermined measurement period, respectively. Therefore, each of the power meters 31 to 34 acts as a measurement value obtaining means configured to obtain a measurement value indicative of an amount of power consumed by devices in the predetermined time period (power consumption of devices in the predetermined time period).

Notably, the power consumption in the branch circuit 61 is defined as a total of power consumption of the plural lighting fixtures L1 to L3 respectively belonging to the zones Z1 to Z3. The power consumption in the branch circuit 62 is defined as a total of power consumption of the plural lighting fixtures L4 belonging to the zone Z4. The power consumption in the branch circuit 63 is defined as a total of power consumption of the plural air conditioners AC1 to AC3 respectively belonging to the zones Z1 to Z3. The power consumption in the branch circuit 64 is defined as a total of power consumption of the plural air conditioners AC4 belonging to the zone Z4. As described in the above, the energy management system of the present embodiment measures power consumption for each group including one or more devices.

Each of the power meters 31 to 34 is configured to store the collected measurement value in an incorporated memory (not shown) thereof. Each of the power meters 31 to 34 is configured to output the measurement value stored in the incorporated memory to the collection device 35 at a predetermined transmission period

The collection device 35 is configured to receive the measurement values output from the power meters 31 to 34. The collection device 35 functions as a first storing means configured to store the measurement values received from the power meters 31 to 34 in association with date and time of measurement thereof. In addition, the collection device 35 is connected to the monitoring device 2 via the communication network NT. The collection device 35 is configured to transmit the measurement values of the branch circuits 61 to 64 to the monitoring device 2 in response to a request from the monitoring device 2 (e.g., upon receiving the after-mentioned monitoring data request signal from the monitoring device 2).

The control device 5A is a lighting control device configured to control operation of the lighting fixtures L1 to L4. The control device 5A transmits/receives a transmission signal including address information to/from the transmission line LN1 to communicate with the desired one of the lighting fixtures L1 to L4, the lighting switches S1 to S4, and the human sensors R1 to R4.

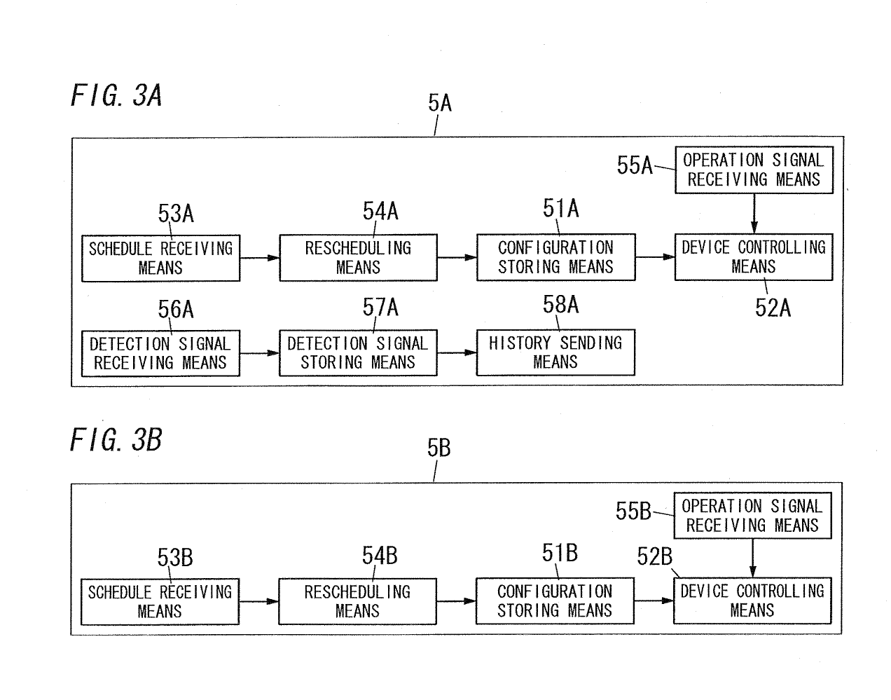

The control device 5A is realized by use of a computer. As shown in FIG. 3A, the control device 5A includes a configuration storing means 51A, a device controlling means 52A, a schedule receiving means 53A, a rescheduling means 54A, an operation signal receiving means 55A, a detection signal receiving means 56A, a detection signal storing means 57A, and a history sending means 58A.

The configuration storing means 51A is configured to store schedule information (operation schedule information) for each of the lighting fixtures L1 to L4.

Besides, the schedule information is information which defines operation of the device for each unit time (predetermined time division) in the predetermined time period. With regard to the control device 5A, for example, the schedule information is information which defines operation (lighting or extinction) of the lighting fixtures L1 to L4 in each of the zones Z1 to Z4 for every 30 minutes within a week. It is noted that the time at which the lighting fixture (L1 to L4) is turned on is referred to as lighting time and that the time at which the lighting fixture (L1 to L4) is turned off is referred to as extinction time.

The schedule receiving means 53A is configured to receive the schedule information from the terminal device 1A and the monitoring device 2.

The rescheduling means 54A is configured to change contents of the schedule information stored in the configuration storing means 51A into contents of the schedule information received at the schedule receiving means 53A. Therefore, upon receiving the schedule information from the terminal device 1A or the monitoring device 2, the control device 5A updates the schedule information stored in the configuration storing means 51A.

The operation signal receiving means 55A is configured to receive the operation signals from the lighting switches S1 to S4.

The device controlling means 52A is configured to control a device in conformity with the corresponding schedule information stored in the configuration storing means 51A. For example, when the current time (time of a clock incorporated in the control device 5A) becomes identical to the lighting time determined by the schedule information, the device controlling means 52A transmits a lighting control signal to the corresponding one of the lighting fixtures L1 to L4 to turn on the same. When the current time becomes identical to the extinction time determined by the schedule information, the device controlling means 52A transmits the lighting control signal to the corresponding one of the lighting fixtures L1 to L4 to turn off the same.

Furthermore, the device controlling means 52A is configured to control the lighting fixtures L1 to L4 in response to the lighting operation signal received by the operation signal receiving means 55A. For example, the device controlling means 52A transmits a control signal to the lighting fixtures L1 to L4 in response to the lighting operation signals from the lighting switches S1 to S4, thereby turning on and off the lighting fixtures L1 to L4. Therefore, according to the control device 5A, it is possible to control the lighting fixtures L1 to L4 at desired time in addition to the time (the lighting time and the extinction time) determined by the schedule information.

The detection signal receiving means 56A is configured to receive detection signals from the human sensors R1 to R4.

The detection signal storing means 57A is configured to prepare a history of the detection signal on the basis of the detection signals received by the detection signal receiving means 55A, and store the prepared history of the detection signal. In other words, the control device 5A stores the history of the detection signal (time at which human presence has been detected).

The history sending means 58A is configured to send the history of the detection signal stored in the detection signal storing means 56A to the terminal device 1A and the monitoring device 2. In addition, the history sending means 58A is configured to send the histories of the detection signal of the human sensors R1 to R4 to the monitoring device 2 upon receiving the after-mentioned detection data request signal from the monitoring device 2.

The control device 5B is an air conditioning control device configured to control operation of the air conditioners AC1 to AC4. The control device 5B transmits/receives a transmission signal including address information to/from the transmission line LN2 to communicate with the desired one of the air conditioners AC1 to AC4.

The control device 5B is realized by use of a computer. As shown in FIG. 3B, the control device 5B includes a configuration storing means 51B, a device controlling means 52B, a schedule receiving means 53B, and a rescheduling means 54B.

The configuration storing means 51B is configured to store schedule information of each of the air conditioners AC1 to AC4. For example, the schedule information is information which defines operation of the air conditioners AC1 to AC4 in each of the zones Z1 to Z4 for every 30 minutes within a week. It is noted that the time at which the air conditioner (AC1 to AC4) is turned on is referred to as operation start time and that the time at which the air conditioner (AC1 to AC4) is turned off is referred to as operation termination time.

The schedule receiving means 53B is configured to receive the schedule information from the terminal device 1A and the monitoring device 2.

The rescheduling means 54B is configured to change contents of the schedule information stored in the configuration storing means 51B into contents of the schedule information received at the schedule receiving means 53B. Therefore, upon receiving the schedule information from the terminal device 1A or the monitoring device 2, the control device 5B updates the schedule information stored in the configuration storing means 51B.

The operation signal receiving means 55B is configured to receive the operation signals from the air conditioning switches, respectively.

The device controlling means 52B is configured to control a device in conformity with the corresponding schedule information stored in the configuration storing means 51B. For example, when the current time becomes identical to the operation start time determined by the schedule information, the device controlling means 52B transmits an operation start signal to the corresponding one of the air conditioners AC1 to AC4 to turn on the same. When the current time becomes identical to the operation termination time determined by the schedule information, the device controlling means 52B transmits an operation termination signal to the corresponding one of the air conditioners AC1 to AC4 to turn off the same.

Furthermore, the device controlling means 52B is configured to control the air conditioners AC1 to AC4 in response to the air conditioning operation signal received by the operation signal receiving means 55B. For example, the device controlling means 52B transmits a control signal to the air conditioners AC1 to AC4 in response to the air conditioning operation signals from the air conditioning switches, thereby turning on and off the air conditioners AC1 to AC4. Therefore, according to the control device 5B, it is possible to control the air conditioners AC1 to AC4 at desired time in addition to the time (the operation start time and the operation termination time) determined by the schedule information.

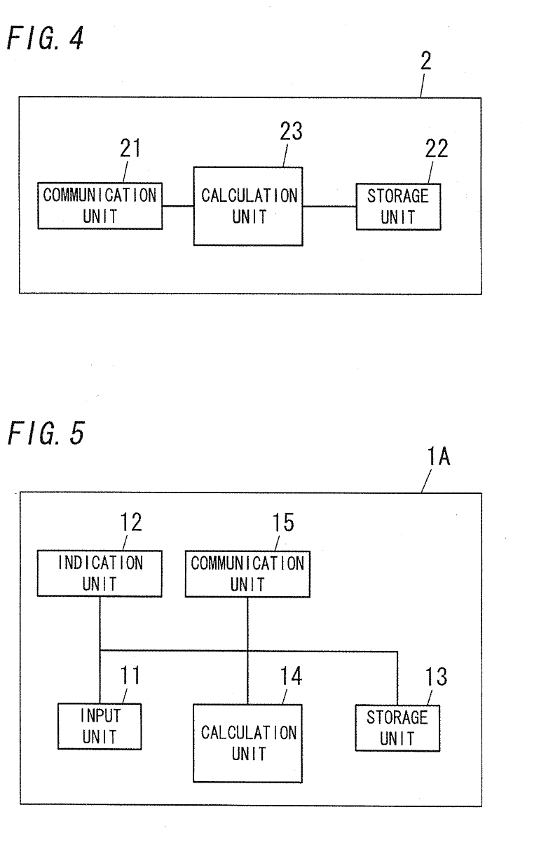

As shown in FIG. 4, the monitoring device 2 includes a communication unit 21, a storage unit 22, and a calculation unit 23. The communication unit 21 is configured to communicate with the measurement device 3 and the control device 5A via the communication network NT. The calculation unit 23 is configured to control the communication unit 21 to transmit the aforementioned monitoring data request signal and the aforementioned detection data request signal each time a predetermined data collection period elapses. The communication unit 21 and the calculation unit 23 constitute a measurement value obtaining means configured to obtain the measurement value from the collection device 35 of the measurement device 3. The storage unit 22 acts as a second storing means configured to store the measurement value received by the communication unit 21. In addition, the storage unit 22 is configured to store the history of the detection signal (the measurement data of the human sensors R1 to R4) received by the communication unit 21. Besides, the monitoring device 2 may be configured to obtain the measurement values from the plural measurement devices 3. This arrangement allows the single monitoring device 2 to manage the measurement values of the plural measurement devices 3.

The terminal devices 1A and 1B have the same configuration. Accordingly, in the following, an explanation is made only to the terminal device 1A.

As shown in FIG. 5, the terminal device 1A is a computer device including an input unit 11, an indication unit 12, a storage unit 13, a calculation unit 14, and a communication unit 15. The input unit 11 is selected from a keyboard, a mouse, and a touch panel, for example. The input unit 11 allows user to select after-mentioned buttons B1 to B24 and to input the schedule information. The indication unit 12 is a display device (e.g., liquid crystal display device) or the like, and is controlled by the calculation unit 14 to make predetermined indication. The storage unit 13 is used for storing programs executed by the calculation unit 14, a measurement result of power consumption, a simulation result of power consumption, and the like. The storage unit 13 is a mass storage (e.g., hard disk), or a memory (e.g., ROM, and RAM). The calculation unit 14 is a CPU or the like, and executes a program stored in the storage unit 13. The communication unit 15 is configured to establish communication through the network NT.

The storage unit 13 stores a program (hereinafter referred to as “energy management program”) of managing power consumption, simulating power consumption and evaluating whether or not consumed power is reasonable. Each of the terminal devices 1A and 1B executes the energy management program to realize a function of managing power consumption, a function of simulating power consumption, and a power evaluating function.

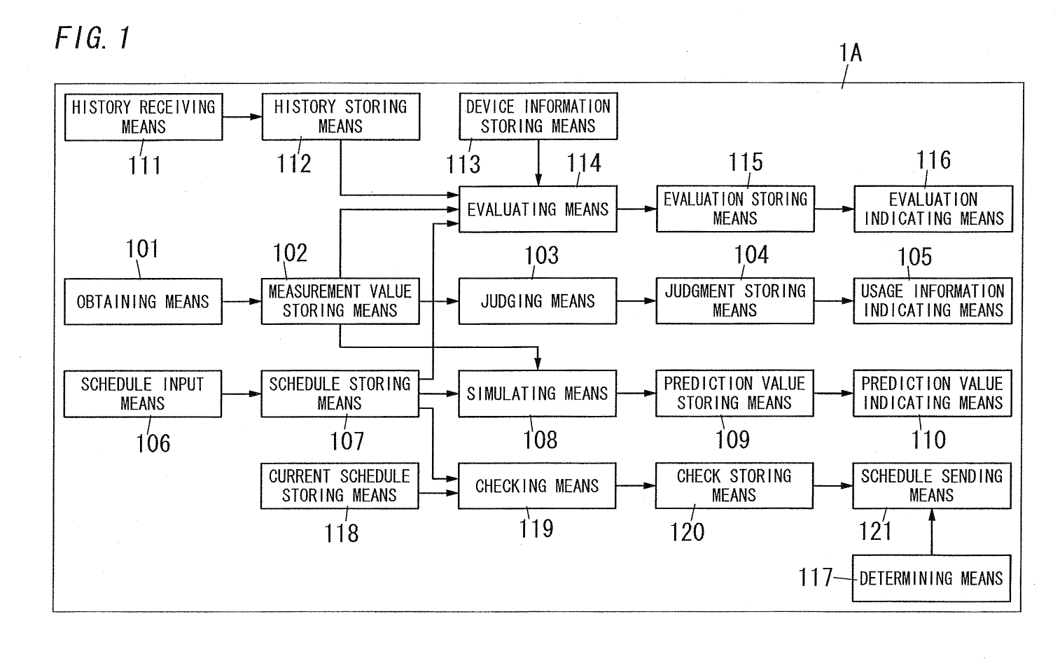

As shown in FIG. 1, in order to manage power consumption of a device, the energy management program controls the terminal device 1A to act as an obtaining means 101, a measurement value storing means 102, a judging means 103, a judgment storing means 104, and a usage information indicating means 105.

The obtaining means 101 is configured to obtain the measurement value indicative of an amount of measured energy resources used in the device in the predetermined time period. In other words, when one or more devices are classified into a single group, the obtaining means 101 is regarded as a power input means which is configured to receive a power measurement result (measurement value) obtained by measuring power consumption per group unit for each time division (unit time).

With the present embodiment, the device is an electric device, such as the lighting fixture (L1 to L4), and the air conditioner (AC1 to AC4). Thus, the energy resources are defined as electricity, and an amount of the energy resource used in the device is defined as power consumption of the device. For example, the obtaining means 101 communicates with the monitoring device 2 and the control devices 5A and 5B via the communication network NT to receive power consumption in the predetermined period (e.g., one week) with regard to each of the branch circuits 61 to 64. In brief, the obtaining means 101 is configured to obtain the measurement value from the above second storing means of the monitoring device 2. The above obtaining means 101 is realized by the calculation unit 14 and the communication unit 15.

The measurement value storing means 102 is configured to store the measurement value obtained by the obtaining means 101. The above measurement value storing means 102 is realized by the storage unit 13 and the calculation unit 14.

The judging means 103 is configured to judge whether or not the device was used for each unit time (e.g., 30 minutes) in the predetermined time period, on the basis of the measurement value stored in the measurement value storing means 102. Notably, in the present embodiment, the judging means does not make judgment concerning a period of time included in the after-mentioned time zone. For example, the judging means 103 compares the measurement value stored in the measurement value storing means 102 with a predetermined threshold. The judging means 103 determines that the device was used only when the measurement value exceeds the predetermined threshold. For example, the predetermined threshold is defined to be equivalent to an amount of standby power consumption of the corresponding branch circuits 61 to 64. In other words, the judging means 103 judges whether or not at least one of devices connected to corresponding one of the branch circuits 61 to 64 was used. The above judging means 103 is realized by the calculation unit 14.

The judgment storing means 104 is configured to store the judgment result indicative of a result obtained by judgment of the judging means 103. The judgment storing means 104 is realized by the storage unit 13 and the calculation unit 14.

The usage information indicating means 105 is configured to indicate whether or not the device was used for each unit time in the predetermined time period, on the basis of the judgment result stored in the judgment storing means 104. In other words, the usage information indicating means 105 indicates at least whether or not electrical power was consumed per group for each time division, on the basis of the power measurement result input into the power input means.

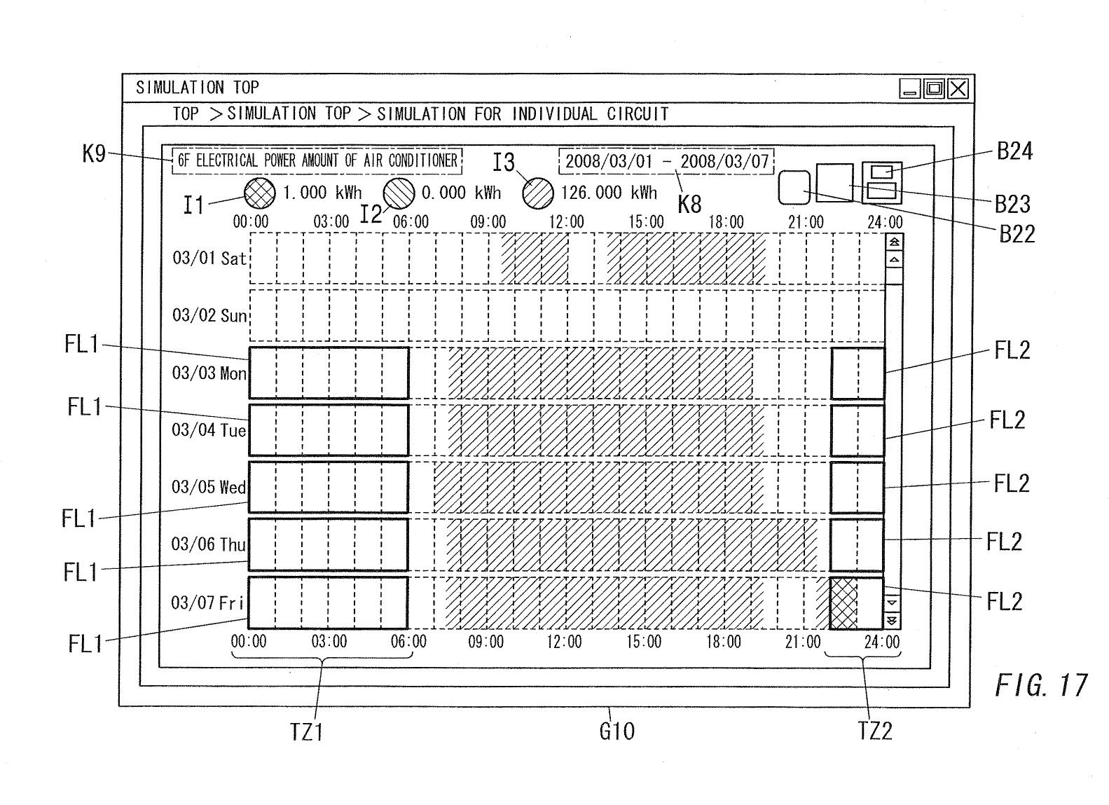

The aforementioned usage information indicating means 105 is configured to convert power consumption of the device in the predetermined time period into two values and indicate the same. For example, as shown in FIG. 17, the usage information indicating means 105 shows unit time in which the device was used and unit time in which the device was not used in a distinctive manner (a period of time in which the device was used is represented by positive slopes, in FIG. 17). In addition, the usage information indicating means 105 is configured to indicate power consumption of the device (total of power consumption of the device in the predetermined time period) numerically. The above usage information indicating means 105 is realized by the indication unit 12 and the calculation unit 14.

In addition, for the purpose of performing simulation of power consumption, the energy management program controls the terminal device 1A to function as a schedule input means 106, a schedule storing means 107, a simulating means 108, a prediction value storing means 109, and a prediction value indicating means 110.

The schedule input means 106 is adapted in use to input the schedule information which defines operation of the device for each unit time in the predetermined time period. In other words, the schedule input means 106 is used by a user for inputting changed contents of the schedule information.

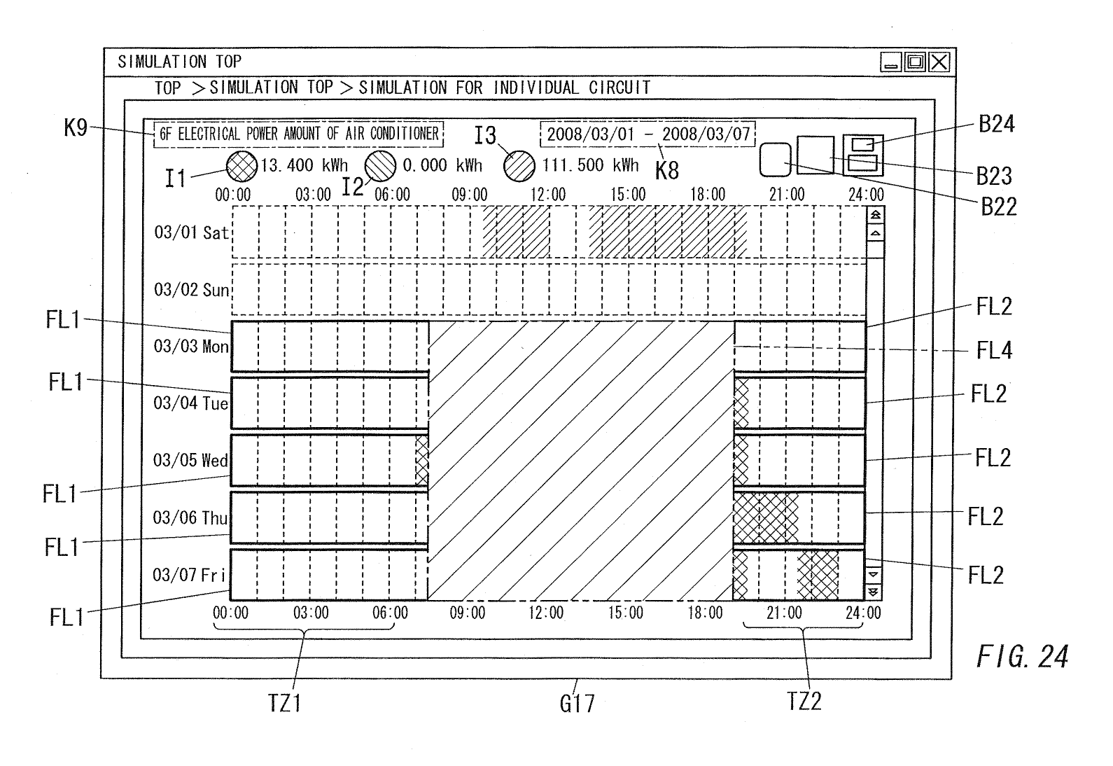

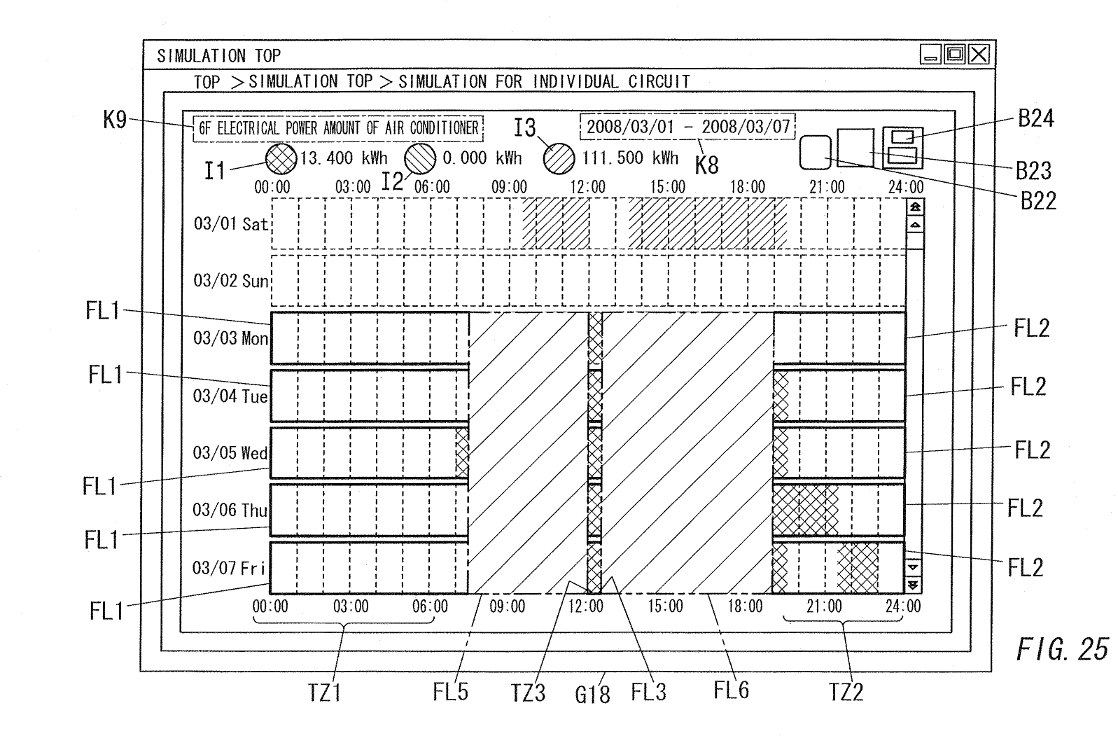

In the present embodiment, the schedule information is described by use of an after-mentioned time zone. That is, a period of time designated by the time zone denotes time in which the device is kept turned off. For example, in the instance shown in FIG. 24, the schedule information indicates that the device is turned on at 7:30 and off at 19:00 from Monday to Friday. Further, in the instance shown in FIG. 25, the schedule information indicates that the device is turned on at 7:30 and off at 12:00 from Monday to Friday, and that the device is turned on at 12:30 and off at 19:00 from Monday to Friday. The above schedule input means 106 is realized by the input unit 11, the indication unit 12, and the calculation unit 14.

The schedule storing means 107 is configured to store the schedule information input by use of the schedule input means 106. The above schedule storing means 107 is realized by the storage unit 13 and the calculation unit 14.

The simulating means 108 is configured to calculate a prediction value on the basis of the measurement value stored in the measurement value storing means 102. The prediction value is indicative of power consumption obtained when the device operates in accordance with the schedule information stored in the schedule storing means 107. In other words, when the schedule input means 106 receives an input of changed contents of the schedule information, the simulating means 108 predicts, on the basis of the power measurement result, power consumption expected when the device operates in conformity with the schedule information after being changed.

For example, the simulating means 108 compares the measurement value stored in the measurement value storing means 102 with the standby power consumption of corresponding one of the branch circuits 61 to 64, thereby estimating the on/off state of the device (the judgment result also may be used for this estimation). Next, the simulating means 108 compares the schedule information stored in the schedule storing means with a result (estimation result) obtained by estimation of whether the device is in the on-state or off-state of the device. For example, it is assumed that the estimation result indicates that the device is kept turned off from 0:00 to 6:00, and is kept turned on from 6:00 to 18:00, and is kept turned off from 18:00 to 24:00, and that the schedule information stored in the schedule storing means 107 indicates that the device is kept turned off from 0:00 to 7:00, and is kept turned on from 7:00 to 19:00, and is kept turned off from 19:00 to 24:00. In this situation, with regard to a time period in which the estimation result and the schedule information indicate the same state, that is, 0:00 to 6:00, 7:00 to 18:00, and 19:00 to 24:00, the measurement value stored in the measurement value storing means 102 is used without modification. In contrast, with regard to a time period in which the estimation, result and the schedule information indicate different states, that is, 6:00 to 7:00, and 18:00 to 19:00, power consumption of the device is predicted. For example, with regard to the time period from 6:00 to 7:00, the estimation result indicates the on-state of the device, and the schedule information indicates the off-state of the device. Therefore, the simulating means 108 selects standby power consumption of corresponding one of the branch circuits 61 to 64 as power consumption per unit time concerning the time period from 6:00 to 7:00. In addition, with regard to the time period from 18:00 to 19:00, the estimation result indicates the off-state of the device, and the schedule information indicates the on-state of the device. Therefore, the simulating means 108 selects power consumption of unit time (e.g., 17:30 to 18:00) closest to unit time in which the electric device was turned on as power consumption per unit time concerning the time period from 18:00 to 19:00. Besides, instead of power consumption of closest unit time, the simulating means 108 may select an average of power consumption of unit time in which the electric device was determined to be turned on, or power consumption of the same unit time regarding past same or different day. As described in the above, the simulating means 108 estimates power consumption of the electric device observed in the predetermined time period.

The prediction value storing means 109 is configured to store the prediction value predicted by the simulating means 108. The above prediction value storing means 109 is realized by the storage unit 13 and the calculation unit 14.

The prediction information indicating means 110 is configured to indicate the prediction value stored in the prediction value storing means 109. The above prediction value indicating means 110 is realized by the indication unit 12 and the calculation unit 14.

Each device is controlled to be turned on and off in conformity with the predetermined schedule information. For example, the schedule information is prepared in order to indicate that all devices are kept turned on during working hours (e.g., in FIG. 24, working hours are from 7:30 to 19:00, Monday to Friday), and that all devices are kept turned off outside the working hours. In this situation, power will not be consumed outside of the working hours, if all devices operate in conformity with the schedule information. However, all devices are not always used in conformity with the schedule. For example, an employee may operate switches (e.g., the lighting switches S1 to S4) to activate desired devices (e.g., lighting fixtures L1 to L4 and air conditioners AC1 to AC4) when the employee would like to work outside the working hours. In this situation, if the employee forgets to turn off a certain device when leaving the office, the certain device will continue to operate. In this instance, consumed power is wasteful because of that use of the certain device is wasteful (e.g., in FIG. 24, cross-hatched portions indicate that use of the device is wasteful).

In view of the above, for the purpose of performing make evaluation of whether or not power consumption of the device is reasonable (whether use of the device is reasonable or wasteful), the energy management program controls the terminal device 1A to function as a history receiving means 111, a history storing means 112, a device information storing means 113, an evaluating means 114, an evaluation storing means 115, and an evaluation indicating means 116.

The history receiving means 111 is configured to receive the history of the detection signal (measurement data of the human sensors R1 to R4). For example, the history receiving means 111 communicates with the monitoring device 2 and the control devices 5A and 5B to receive the history of the detection signal (measurement data of the human sensors R1 to R4) obtained in the predetermined time period. The above history receiving means 111 is realized by the calculation unit 14 and the communication unit 15.

The history storing means 112 is configured to store the history of the detection signal received by the history receiving means 111. The above history storing means 112 is realized by the storage unit 13 and the calculation unit 14.

The device information storing means 113 is configured to store device information for each device. Notably, the device information includes a type of the device, and the installation site indicative of a place in which the device is installed. For example, the type of the device is selected from one of a lighting fixture, an air conditioner, and the like. The installation site of the device is selected from one of the zone Z1 to Z4. For example, the device information storing means 113 stores, for the device L1, the device information which indicates that the type is “lighting fixture” and that the installation site is “zone Z1”. The above device information storing means 113 is realized by the storage unit 13 and the calculation unit 14.

The evaluating means 114 is configured to evaluate, on the basis of the measurement value stored in the measurement value storing means 102 and the schedule information stored in the schedule storing means 107, whether use of the device is reasonable or wasteful for each unit time. In other words, the evaluating means 114 is a power evaluating means configured to evaluate, on the basis of the schedule information and power consumption in each time division input into the power input means, whether power consumption in each time division is reasonable or wasteful. The above evaluating means 114 is realized by the calculation unit 14.

For example, the evaluating means 114 determines that use of the device is wasteful when the device which should be kept turned off in conformity with the schedule information thereof was kept turned on.

For example, the evaluating means 114 selects, with reference to the schedule information (in the present embodiment, the time zone) stored in the schedule storing means 107, the measurement value of a time period (time period included in the time zone) in which the device is kept turned off. The evaluating means 114 compares the selected measurement value with the predetermined threshold (standby power consumption of corresponding one of the branch circuits 61 to 64). The evaluating means 114 determines that use of the device is wasteful when the measurement value exceeds the predetermined threshold. For example, in the instance shown in FIG. 17, it is determined that use of the device in the time period from 22:00 to 23:00 on March 7 (Fri) is wasteful.

Besides, the evaluating means 114 may be configured to, when a variation with time of the measurement value stored in the measurement value storing means 102 fulfills a prescribed condition, determine that use of the device is wasteful. The prescribed condition is defined as a condition where a period in which the measurement value exceeds the predetermined threshold is kept over a predetermined time. For example, the evaluating means 114 determines that use of the device is wasteful when the measurement value exceeds the predetermined threshold successively more than prescribed times (e.g., three times). With this arrangement, the evaluating means 114 can be free from erroneously determining that the use of the device is wasteful in response to a possible measurement error caused by a noise, in a situation where the use of the device is not wasteful.

In some cases, use of the device may be reasonable even if the device which should be turned off according to the schedule information is actually turned on. For example, when an employee works outside of the working hours, use of the device is considered to be reasonable.

In view of the above, the evaluating means 114 is configured to, when a certain unit time in which it is determined that use of the device is wasteful fulfils a predetermined exception condition (exception rule), determine that use of the device in the certain time is reasonable. With this arrangement, it is possible to judge more precisely whether or not use of the device is reasonable.

The exception condition may be defined as a condition where corresponding one of the human sensors R1 to R4 detects human presence in the installation site of the device. For example, upon determining that use of the device is wasteful, the evaluating means 114 retrieves information of the installation site of the device from the device information storing means 113. Thereafter, the evaluating means 114 determines (redetermines) that use of the device is reasonable when the human sensor (R1 to R4) placed in the same zone (Z1 to Z4) as the device outputs the detection signal in the unit time in which the use of device is determined to be wasteful. With this arrangement, it is determined that use of the device in a site where a human exists is not wasteful. Therefore, it is possible to make evaluation in line with the current condition. Besides, for example, when a situation where an employee works outside of the working hours (e.g., an employee works earlier or overtime) or a situation where an employee does not forget to turn off the device after using the device in the time zone, the evaluating means 114 may rely on the exception condition so as to determine that use of the device is not wasteful. Therefore, it is possible to use the exception condition corresponding to the above situation.

Further, the evaluating means 114 is configured to, when the plural devices having different types exist on the same installation site, evaluate, on the basis of a combination of he type of each device and the judgment result of the judging means 103, whether use of the device is reasonable or wasteful. For example, the evaluating means 114 judges, on the basis of the type and the installation site for each device stored in the device information storing means 113, whether or not a plurality of the devices having different types exists on the same installation site. Upon determining the plurality of the devices having different types exists on the same installation site, the evaluating means 114 evaluates, on the basis of the combination of the type of each device and the judgment result, whether use of the device is reasonable or wasteful. With this arrangement, it is possible to precisely judge whether use of the device is reasonable or wasteful. For example, when the device to be evaluated is the lighting fixture L1, the air conditioner AC1 which is different from the lighting fixture L1 in the type is in the installation site (zone Z1) of the lighting fixture L1. In this instance, the evaluating means 114 retrieves the judgment results of each of the lighting fixture L1 and the air conditioner AC1 from the judgment storing means 104. The evaluating means 114 determines that use of the lighting fixture L1 is reasonable when a combination of operation conditions of the lighting fixture L1 and the air conditioner AC1 which have different types from each other is equivalent to a predetermined combination (e.g., both the lighting fixture L1 and the air conditioner AC1 are turned on). In other words, when only one of the lighting fixture L1 and the air conditioner AC1 in the same zone Z1 is turned on, the evaluating means 114 determines that an employee forgot to turn it off.

The evaluation storing means 115 is configured to store an evaluation result indicative of a result obtained by evaluation of the evaluating means 114. The above evaluation storing means is realized by the storing unit 13 and the calculation unit 14.

The evaluation indicating means 116 is configured to indicate whether use of the electric device is reasonable or wasteful for each unit time, on the basis of the evaluation result stored in the evaluation storing means 115. For example, the evaluation storing means 116 shows unit time in which use of the device is wasteful and unit time in which use of the device is reasonable in a distinctive manner (a period of time in which use of the device is wasteful is cross-hatched, in FIG. 24). The above evaluation indicating means 116 is realized by the indication unit 12 and the calculation unit 14.

Further, in order to change the schedule information of the control devices 5A and 5B from remote locations, the energy management program controls the terminal device 1A to function as a configuration device including a determining means 117, a current schedule storing means 118, a checking means 119, a check storing means 120, and a schedule sending means 121.

The determining means 117 is adapted in use to determine change of the schedule information stored in the configuration storing means 51A and 51B of the control devices 5A and 5B (see FIG. 25). The above determining means 117 is realized by the input unit 11, the indication unit 12, and the calculation unit 14.

The current schedule storing means 118 is configured to store the schedule information stored in the configuration storing means 51A and 51B. For example, the current schedule storing means 118 receives and stores the schedule information stored in the configuration storing means 51A and 51B from the control devices 5A and 5B via the communication network NT, respectively. The above current schedule storing means 118 is realized by the storage unit 13, the calculation unit 14, and the communication unit 15.

The checking means 119 is configured to check whether or not the schedule information stored in the schedule storing means 107 is identical to the schedule information stored in the current schedule storing means 118. The above checking means 119 is realized by the calculation unit 14.

The check storing means 120 is configured to store a check result indicative of a result obtained by check of the checking means 119. The above check storing means 120 is realized by the storage unit 13 and the calculation unit 14.

The schedule sending means 121 is configured to send the schedule information to the control devices 5A and 5B. The schedule sending means 121 refers to the check result stored in the check storing means 120 when change of the schedule information stored in the configuration storing means 51A and 51B is determined by use of the determining means 117. Thereafter, the schedule sending means 121 sends only changed schedule information to the corresponding control devices 5A and 5B. That is, the schedule sending means 121 sends the schedule information necessitated to be changed to the control devices 5A and 5B. The above schedule sending means 121 is realized by the calculation unit 14 and the communication unit 15. Alternately, the schedule sending means 121 may be configured to send all the schedule information stored in the schedule storing means 107 to the control devices 5A and 5B. With this arrangement, the current schedule storing means 118, the checking means 119, and the check storing means 120 are optional.

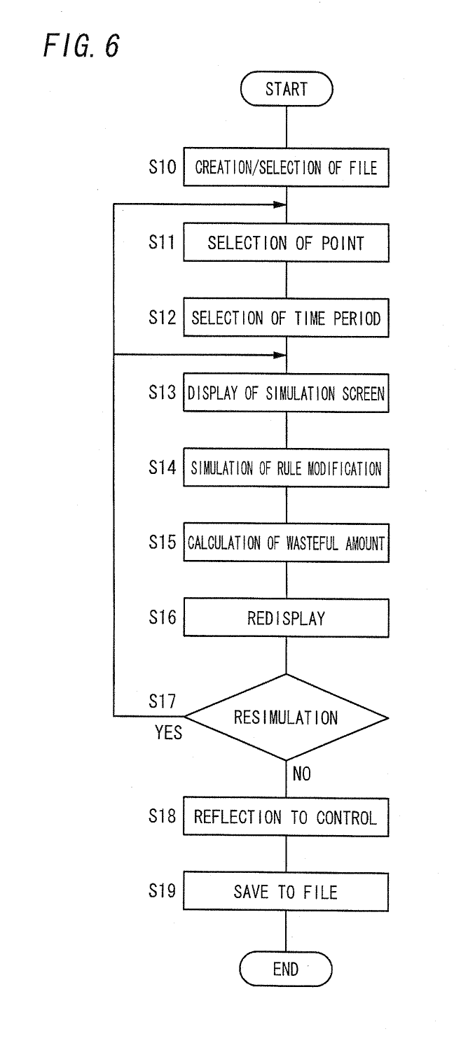

Next, an explanation is made to an instance of operation of the terminal device 1A with reference to FIGS. 6 to 27. Besides, FIG. 6 shows a flow chart illustrating operation of the terminal device 1A executing the simulation.

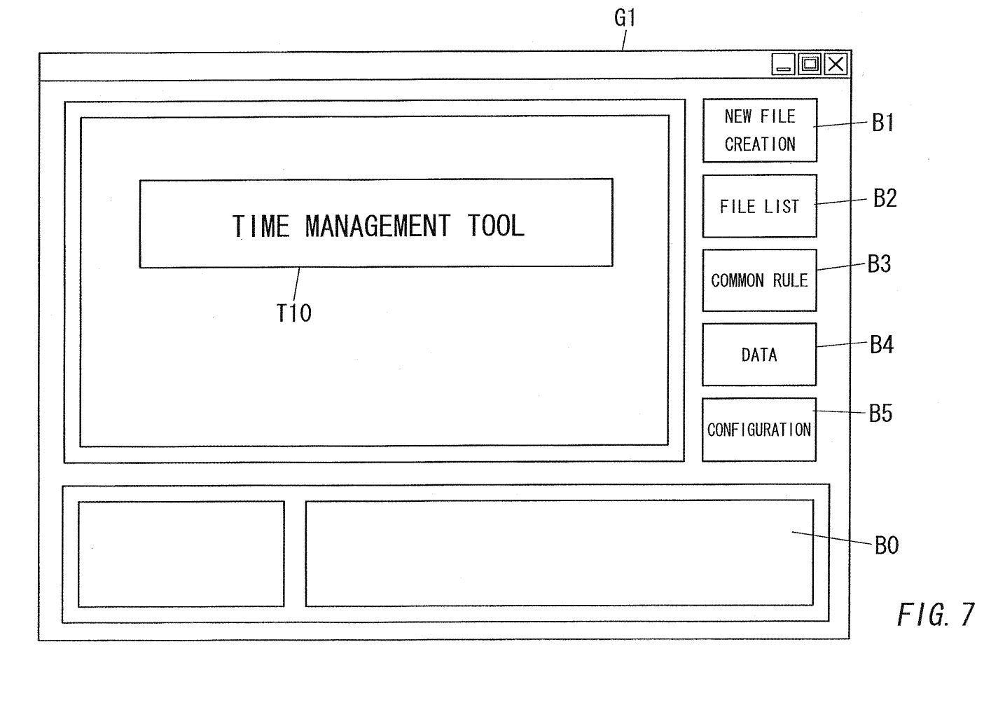

The calculation unit 14 of the terminal device 1A executes the energy management program stored in the storage unit 13, thereby controlling the indicating unit 12 to indicate an initial screen G1 shown in FIG. 7.

A title T10 indicating “TIME MANAGEMENT TOOL” is displayed on the center of the initial screen 51, for example. The five buttons B1 to B5 respectively corresponding to “NEW FILE CREATION”, “FILE LIST”, “COMMON RULE”, “DATA”, and “CONFIGURATION” are displayed on the right side area of the initial screen G1. In this instance, when a mouse cursor is hovered over one of the buttons B1 to B5 (mouse over), a blank space on the lower portion of the initial screen G1 is turned to show an explanation of a function corresponding to one of the buttons B1 to B5 over which the mouse cursor is positioned.

The button B1 serves to start a processing of predicting power consumption observed when the schedule information is changed. In the energy management system of the present embodiment, it is possible to attach a name to a file storing a simulation result and to save and manage the same.

The button B2 serves to call up the saved file (file storing the simulation result). It is possible to modify a parameter (schedule information) on the basis of the simulation result stored in the file. Further, it is possible to execute the simulation again.

The button B3 serves to execute creation, change, and deletion of the common rule. The common rule is defined as a rule used for evaluating, for each time division (unit time), whether or not consumed power is reasonable (i.e., whether use of the electric device is reasonable or wasteful). The button B3 is used for determination of measurement point to which the created common rule is applied.

The button B4 serves to select a processing of retrieving the data of power consumption which has been collected by the other system. For example, in the energy management system of the present embodiment, the terminal devices 1A and 1B are connected to the central monitoring board 2 via the communication network NT. In this situation, the terminal devices 1A and 1B collect automatically the data of power consumption from the central monitoring board 2 by use of the power consumption receiving means 101, and store the collected data of power consumption in a database of the measurement value storing means 102.

The button B5 serves to select a processing (configuration processing) of defining various pieces of information used in the energy management program. The configuration processing is used for defining information of the measurement point corresponding to the received power consumption, parameters used for the simulation, and the like.

Besides, in an initial configuration, the energy management system of the present embodiment requires a user to define five configurations: a configuration of the measurement point, a common rule creation, association of the common rule with the measurement point, a configuration of parameters, and import of an energy data (measurement result of power consumption). The above processing for executing the initial configuration can be performed from the initial screen G1.

The “configuration of the measurement point” serves to define items, such as a name of the measurement point (e.g., electric lamp of 1 F common use space), a type of an input data (e.g., PI, AI, configuration, DI, and DO), an collection interval of power consumption, and a threshold (standby power consumption, when the measurement data is power consumption) defined for each measurement point in order to judge whether an electric device is on or off.

The “common rule creation” serves to define items such as a name of the common rule to be created, information of the time zone to which the created common rule is applied, and information of the measurement point to which the created common rule is applied.

Notably, the time zone is defined as a period of time in which the energy management system judges whether or not electrical power is wasted. Power consumption in a period of time designated by the time zone is selected as a candidate of the evaluation by the evaluating means 114. In contrast, power consumption in a period of time not designated by the time zone is selected as a candidate of judgment by the judging means 103. The time zone is defined according to the schedule information input.

The time zone is defined by four components: a name of the time zone, a day of the week (a day of the week to be monitored), time (time to be monitored), and a judgment logic. The judgment logic is defined as a logic for judging whether use of the electric device is reasonable or wasteful (unprofitable). In other words, the judgment logic designates an evaluation method used by the evaluating means 114.

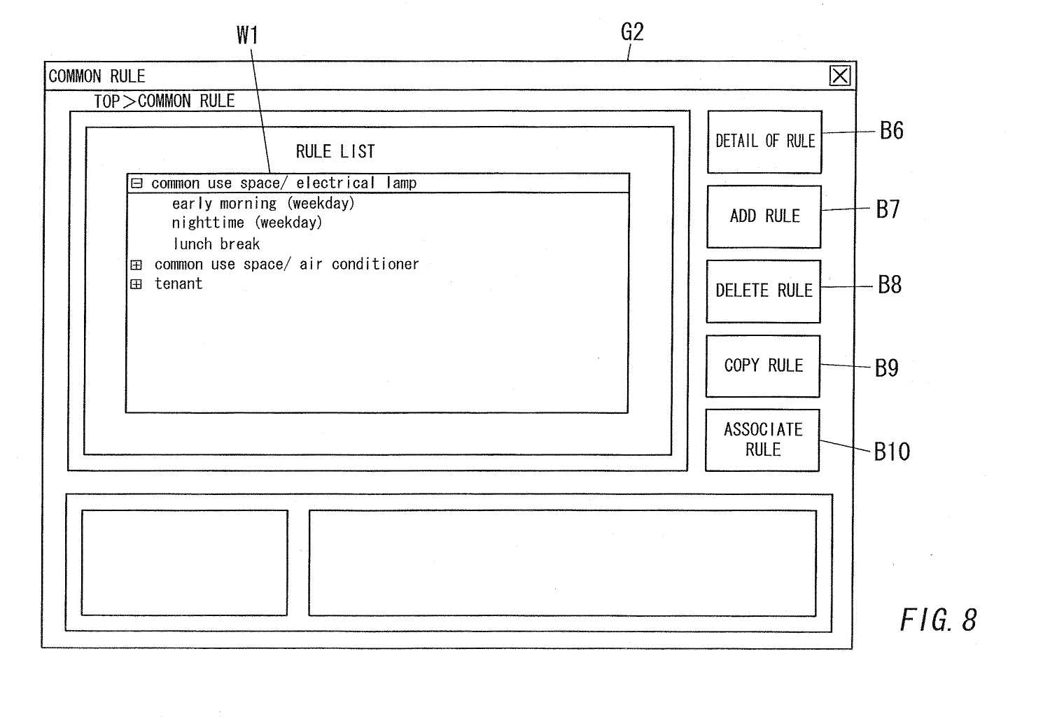

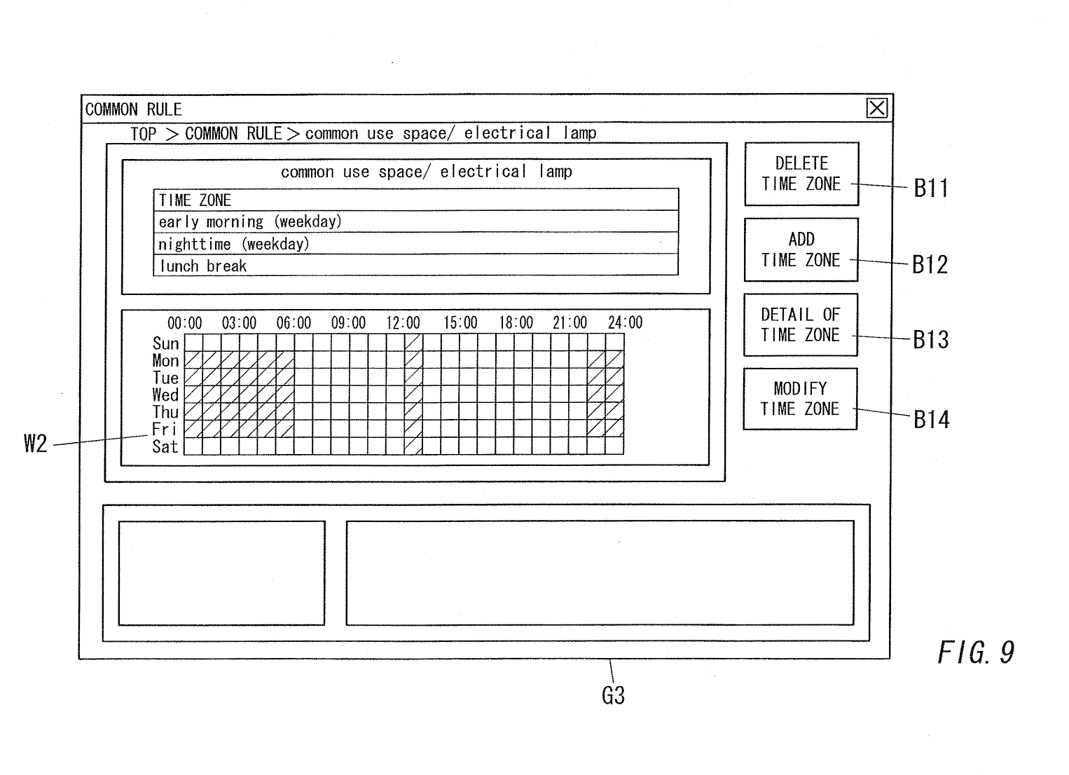

Next, with reference to FIGS. 8 and 9, an explanation is made to a processing for creating the common rule.

When the button B3 is selected in the initial screen G1, the calculation unit 14 controls the indication unit 12 to display a screen (configuration screen) G2 for creating the common rule, as shown in FIG. 8.

A window W1 is displayed on an upper central part of the configuration screen G2. The window W1 displays a list of the common rules which have so far been created. In the instance shown in FIG. 8, the common rule named “common use space/electrical lamp” includes three time zones of early morning (weekday), nighttime (weekday), and lunch break.

In addition, the configuration screen G2 displays the buttons B6 to B10 respectively corresponding to “DETAIL OF RULE”, “ADD RULE”, “DELETE RULE”, “COPY RULE”, and “ASSOCIATE RULE”.

The button B8 serves to delete the common rule selected by a user via the input unit 11. When the button B8 is selected, the calculation unit 14 deletes the selected common rule.

The button B9 serves to copy the common rule selected by a user via the input unit 11. When the button B9 is selected, the calculation unit 14 copies the selected common rule.

The button B7 serves to create a new common rule. When the button B7 is selected, the calculation unit 14 controls the indication unit 12 to display a pop-up screen for inputting a name of a common rule to be newly created. The pop-up screen allows a user to input the name by use of the input unit 11. When the user completes operation after inputting the name, the new common rule is added to the window W1.

The button B6 serves to display the detail of the common rule. When a user selects the button B6 while selecting the common rule, the calculation unit 14 controls the indication unit 12 to display a screen (rule description screen) G3 shown in FIG. 9.

The names of the time zones which have been already defined are displayed on an upper central part of the rule description screen G3.

A window W2 is displayed on a lower side portion of the rule description screen G3. The window W2 shows a graph indicating periods of time to which the common rule is applied. With regard to this graph, a lateral axis denotes time (00:00 to 24:00), and a vertical axis denotes a day of the week (Sunday to Saturday). In FIG. 7, the three time zones, that is, early morning (weekday), nighttime (weekday), and lunch break are set. Further, in FIG. 7, a strip part (hereinafter referred to as “cell”) corresponding to a period of time included in the time zone in the graph is represented with hatching.

The buttons B11 to B14 are displayed on a right side portion of the rule description screen G3. The buttons B11 to B14 are respectively corresponding to “DELETE TIME ZONE”, “ADD TIME ZONE”, “DETAIL OF TIME ZONE”, and “MODIFY TIME ZONE”.

When the button B11 is selected, the calculation unit 14 executes a processing of deleting the selected time zone.

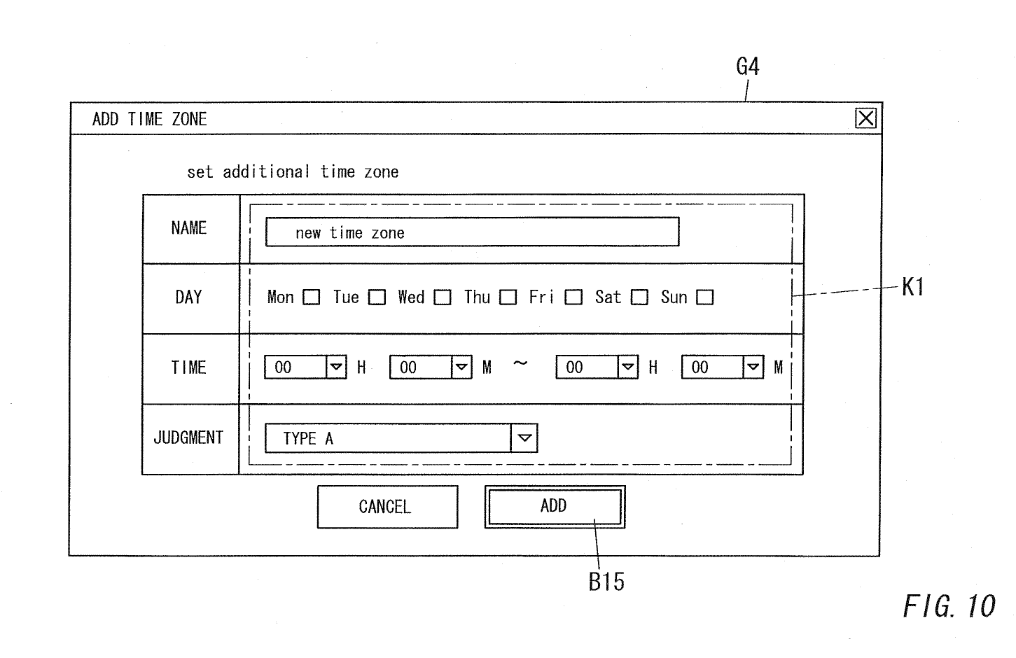

When the button B12 is selected, the calculation unit 14 controls the indication unit 12 to display a screen (pop-up screen) G4 shown in FIG. 10. A block K1 for inputting information of the time zone (i.e., name, day, time, and judgment logic) is displayed on the center of the pop-up screen G4. In addition, the button B15 corresponding to “add” is displayed on a lower portion of the pop-up screen G4. When the adding button B15 is selected, the calculation unit 14 executes a processing of adding a new time zone defined by information inputted in the block K1.

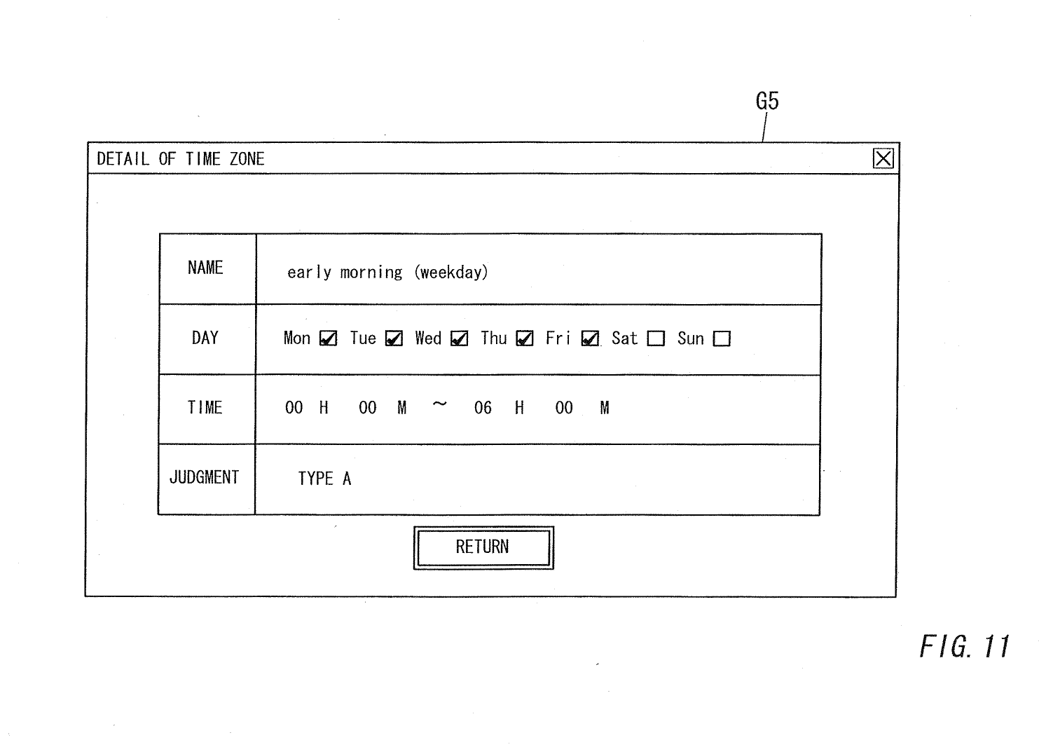

When the button B13 is selected, as shown in FIG. 11, the calculation unit 14 controls the indication unit 12 to display a screen (pop-up screen) G5 for confirming information (configuration contents) of the selected time zone. With regard to the time zone displayed on the pop-up screen G5 shown in FIG. 9, the name is “early morning (weekday)”, and the day of the week is “Monday to Friday”, and the time is “AM 0:00 to AM 6:00”, and the judgment logic is “type-A”.

When the button B14 is selected, the calculation unit 14 controls the indication unit 12 to display a screen (not shown) for modifying the time zone. This screen can be applied the pop-up screen G4 to.

For example, three judgment logics A to C (i.e., types A to C) are prepared.

FIG. 27A shows the judgment result obtained by use of the judgment logic A, and FIG. 27B shows the judgment result obtained by use of the judgment logic B, and FIG. 27C shows the judgment result obtained by use of the judgment logic C.

In the instance shown in FIG. 27, the time zone designates periods of time from 0:00 to 7:00 and from 10:00 to 24:00. In this instance, the time division represented with positive slopes is defined as the time division in which the evaluating means 114 determined that power consumption in the electric device is reasonable (use of the electric device is reasonable). The cross-hatched time division is defined as the time division in which the evaluating means 114 determined that power consumption in the electric device is wasteful (use of the electric device is wasteful).

In the instance of the judgment logic A, the evaluating means 114 collects power consumption (the measurement value stored in the measurement value storing means 102) in the time period as well as the day of week designated by the time zone, and compare the power consumption with the predetermined threshold (value corresponding to standby power consumption of the branch circuit). The evaluating means 114 determines that consumed power is wasteful when power consumption exceeds the threshold (see FIG. 27A). In the instance shown in FIG. 27A, with regard to the time zones of 0:00 to 7:00 and 10:00 to 24:00, use of the electric device in unit time included in the four periods of time (i.e., 0:00 to 2:00, 5:00 to 6:00, 11:00 to 14:00, and 16:00 to 24:00) is determined to be wasteful. Besides, in this instance, the evaluating means 114 may determine that use of the electric device is reasonable when the measurement value does not exceed the threshold successively more than three times. With this arrangement, it is possible to prevent occurrence of erroneous decision caused by a measurement error of power consumption.

The judgment logic B is defined as a logic for judging whether or not waste of power is due to forgetting of turning off the device in nighttime. In the instance of the judgment logic B, the evaluating means 114 collects power consumption in the time period designated by the time zone, and compare the power consumption with the predetermined threshold (standby power consumption). The evaluating means 114 determines that consumed power is wasteful when power consumption exceeds the threshold. In the instance shown in FIG. 27B, with regard to the time zone of 0:00 to 7:00 and 10:00 to 24:00, use of the electric device in unit time included in the four periods of time (i.e., 0:00 to 2:00, 5:00 to 6:00, 11:00 to 14:00, and 16:00 to 24:00) is determined to be a using period. The evaluating means 114 treats a time series of successive usage periods as a single usage period. Therefore, in the instance shown in FIG. 27B, the evaluating means 114 considers time periods of 0:00 to 2:00, 5:00 to 6:00, 11:00 to 14:00, and 16:00 to 24:00 as a single usage period, respectively. Further, the evaluating means 114 determines that a usage period including the end of the time zone (24:00, in the instance shown in FIG. 27B) is a period in which use of the electric device is wasteful. That is, the evaluating means 114 determines that only a usage period (16:00 to 24:00, in the illustrated instance) including the end of the time zone (e.g., 24:00) indicates waste of power due to forgetting of turning off the device (see FIG. 27B). Besides, the evaluating means 114 regards a usage period devoid of the end of the time zone as an undefined part for which the evaluating means 114 cannot judge whether use of the electric device is reasonable or wasteful. According to the aforementioned judgment logic B, even when an employee manipulates a switch to turn on and off the lighting fixture more than once after the lighting fixture is turned off in conformity with the schedule information, it is possible to determine that power consumed after the lighting fixture has been turned on last time is wasteful.

The judgment logic C is defined as a logic for judging whether or not waste of power is due to forgetting of turning off the device in early morning. The judgment logic C is different from the judgment logic B in criteria of judging whether or not a using period is a period in which use of the electric device is wasteful. In the instance of the judgment logic C, the evaluating means 114 determines that a usage period including the beginning of the time zone (0:00, in the instance shown in FIG. 27B) is a period in which use of the electric device is wasteful. That is, the evaluating means 114 determines that only a usage period (0:00 to 2:00, in the illustrated instance) including the beginning of the time zone (e.g., 0:00) indicates waste of power due to forgetting of turning off the device (see FIG. 27C). Besides, the evaluating means 114 regards a usage period devoid of the beginning of the time zone as an undefined part for which the evaluating means 114 cannot judge whether use of the electric device is reasonable or wasteful. According to the aforementioned judgment logic C, even when an employee manipulates a switch to turn on and off the lighting fixture more than once after the lighting fixture is turned off in conformity with the schedule information, it is possible to determine that power consumed before the lighting fixture is turned on first time is wasteful.

These judgment logics B and C are defined to compare a variation pattern of power consumption of the electric device with a predetermined variation pattern (variation pattern based on the schedule information) to judge whether use of the electric device is reasonable or wasteful. For example, the predetermined variation pattern is a variation pattern obtained when use of the electric device is reasonable (e.g., a variation pattern not including the beginning or the end of the time zone), or a variation pattern obtained when use of the electric device is wasteful (e.g., a variation pattern including the beginning or the end of the time zone).

According to these judgment logics B and C, it is possible to easily judge, by means of judging whether or not the variation pattern of power consumption of the electric device is conformity with the predetermined pattern, whether use of the electric device is reasonable or wasteful. In addition, in contrast to the judgment logic A which simply judges whether or not use of the device is reasonable on the basis of determining whether or not power consumption exceeds the predetermined threshold, the judgment logics B and C can judge accurately whether use of the device is reasonable or wasteful, without requiring any complicated configuration.

Alternatively, it is sufficient to use the judgment logic of determining that a using period including a certain time (e.g., 24:00) selected from using periods in which power consumption exceeds the predetermined threshold indicates waste due to forgetting of turning off the device.

The aforementioned judgment logic can successfully identify wasteful consumption due to forgetting of turning off the device, only with small number of setting items. Besides, the time zone is not necessarily determined in direct correspondence to the scheduled time, but may be determined in relative correspondence thereto. For example, it is possible to determine the time period starting at 3 hours after sunset and ending at 24:00 in which the judgment is made as to whether or not an employee forgets turning off the electric device in nighttime. It is also possible to determine the time period starting at 0:00 and ending at sunrise in which the judgment is made as to whether or not an employee forgets turning off the electric device in early morning. Time of sunset or sunrise can be obtained from an external server (not shown) via the communication network NT. In a situation where the last exit time is obtained from an access control device controlling entry to or exit from a prescribed area, a time period which starts at the last exit time and ends at 24:00 may be selected as a time period in which the judgment is made as to whether or not an employee forgets turning off the electric device in nighttime. In this instance, addition of presence or absence of a user (power user) to a judgment condition is very reasonable to improve judgment accuracy of wasteful power consumption. Also with the use of an output signal from a human sensor, the same effect can be expected. Moreover, when the building where the electric device is installed is a store, a time period from a closing hour to 24:00 may be selected as the time period in which the judgment is made as to whether or not the electric device fails to be turned off. A monitoring time period, in which the failure of turning off the electric device is judged, can be defined in accordance with varying environmental requirements different from seasons or styles. With this arrangement, it is possible to make judgment in accordance with the season and operation of the store, and judgment accuracy is expected to be more improved.

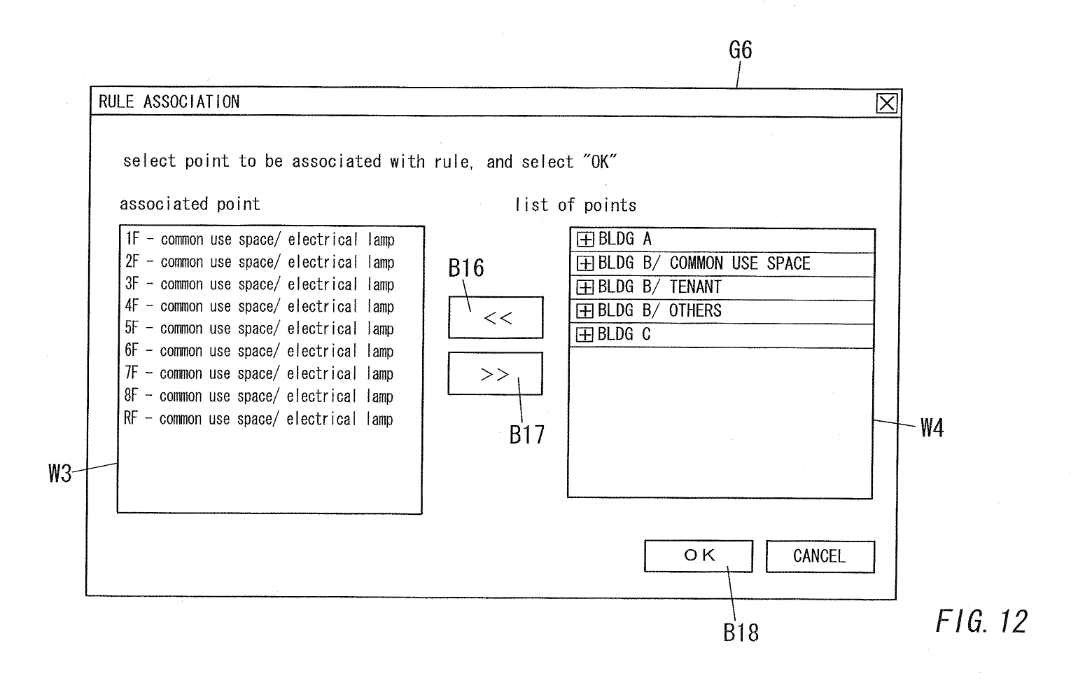

When the button B10 is selected in the configuration screen G2, the calculation unit 14 controls the indication unit 12 to display a pop-up screen G6 shown in FIG. 12. The pop-up screen G6 displays a left space W3 displaying the name of the measurement point (e.g., “1 F—common use space/electric lamp) associated with the common rule, and a right space W4 displaying the measurement points which are candidates associable with the common rule. In the energy management system of the present embodiment in which the measurement point is associated with the group, the measurement points of the associable candidates are displayed in a hierarchical manner.

In addition, the pop-up screen G6 displays a set button B16, a cancel button B17, and an OK button B18.

When the set button B16 is selected, the calculation unit 14 moves one or more measurement points selected in the right space W4 to the left space W3 and associates the same with the common rule. Thereafter, when the OK button B18 is selected, the calculation unit 14 saves a result obtained by selecting the set button B16 and executes processing of closing the pop-up screen G6. Consequently, in order to make association, a user is required to select the set button B16 after selecting one or more measurement points which the user would like to associate with the common rule from the right space W4, and subsequently select the OK button B18.

When the cancel button B17 is selected, the calculation unit 14 moves one or more measurement point selected in the left space W3 to the right space W4 and cancels the association of the selected measurement points with the common rule. Thereafter, when the OK button B18 is selected, the calculation unit 14 saves a result obtained by selecting the cancel button B17 and executes processing of closing the pop-up screen G6. Consequently, in order to cancel the association of the measurement point with the common rule, a user is required to select the cancel button B17 after selecting the desired measurement points from the measurement points displayed on the left space W3, and subsequently select the OK button B18.

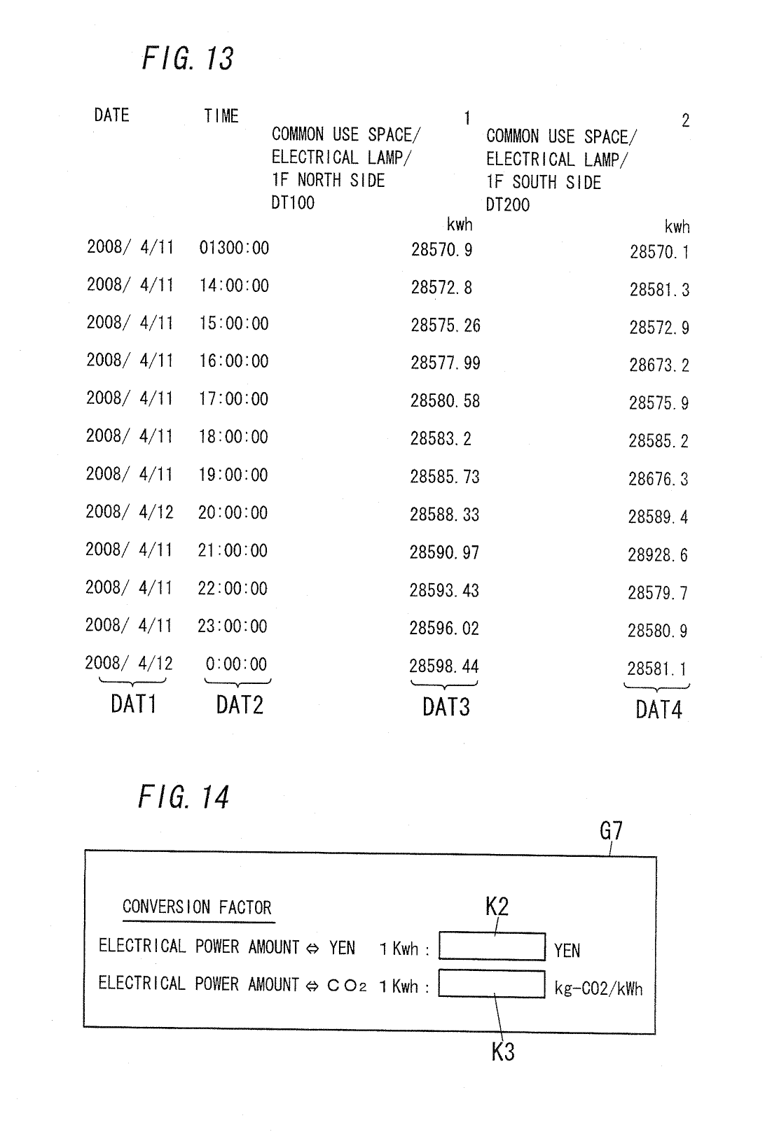

When the button B4 is selected in the initial screen G1 the power consumption receiving means 101 executes processing of importing a data of power consumption collected by the other system (a system different from the energy management system). For example, it is assumed that a storage medium (e.g., memory card) stores a file saved in CSV format which indicates a data of power consumption collected by the other system. In this situation, the storage medium is inserted into a reader of the terminal device 1A. Thereafter, when the button B4 is selected, the power consumption receiving means 101 imports the above file from the storage medium. FIG. 13 shows contents of the above file. The file shown in FIG. 13 is saved in CSV format, and has four data columns DAT1 to DAT4. The leftmost data column DAT1 in FIG. 13 indicates date. The data column DAT2 indicates time. The data column DAT3 indicates power consumption in north of the common-use-space_electric-lamp_{—}1 F which is measured per an hour. The data column DAT4 indicates power consumption in south of the common-use-space_electric-lamp_{—}1 F which is measured per an hour. In addition, a header of the file describes units, and texts which respectively indicate contents of the data columns DAT1 to DAT4, for example.

When the button B5 is selected in the initial screen G1, the calculation unit 14 controls the indication unit 12 to display a parameter configuration screen G7 as shown in FIG. 14.

The configuration screen G7 serves to input, as a parameter, a coefficient (corresponding value) for converting power consumption into an electricity rate or an amount of CO₂ emission. Besides, a unit of power consumption is not limited to kilowatt-hour (kwh), and may be selected from one of British thermal unit (Btu) and megajoule (MJ). That is, a unit suitable for a current situation of a nation can be adopted as a unit for power consumption or an electricity rate.

The configuration screen G7 shows an input block K2 for inputting a corresponding value for converting power consumption into an electricity rate, and an input block K3 for inputting a corresponding value for converting power consumption into an amount of CO₂ emission. The calculation unit 14 stores the corresponding values input into the input blocks K2 and K3 in the storage unit 13, respectively. Each corresponding value stored in the storage unit 13 is used in the following calculation. Besides, a user may input a corresponding value by use of the input unit 11. Alternatively, the calculation unit 14 may control the communication unit 15 to access to a certain server in order to download a corresponding value (in other words, the terminal devices 1A and 1B may automatically determine a corresponding value). Besides, in FIG. 14, power consumption is displayed. Water consumption may be displayed when a managed device is a toilet which uses water, and gas consumption may be displayed when a managed device is a stove burner or a water boiler which uses gas. In this situation, the energy management system may be configured to receive a coefficient for converting water usage ([m³]) into a water rate, or a coefficient for converting gas usage ([Nm³]) into a gas rate.

Next, an explanation is made to processing of simulating a variation of power consumption obtained when the schedule information is changed by use of the terminal device 1A.

When the button B1 or B2 is selected in the initial screen G1, processing for creating or selecting a file for storing a simulation result is made (step S10).

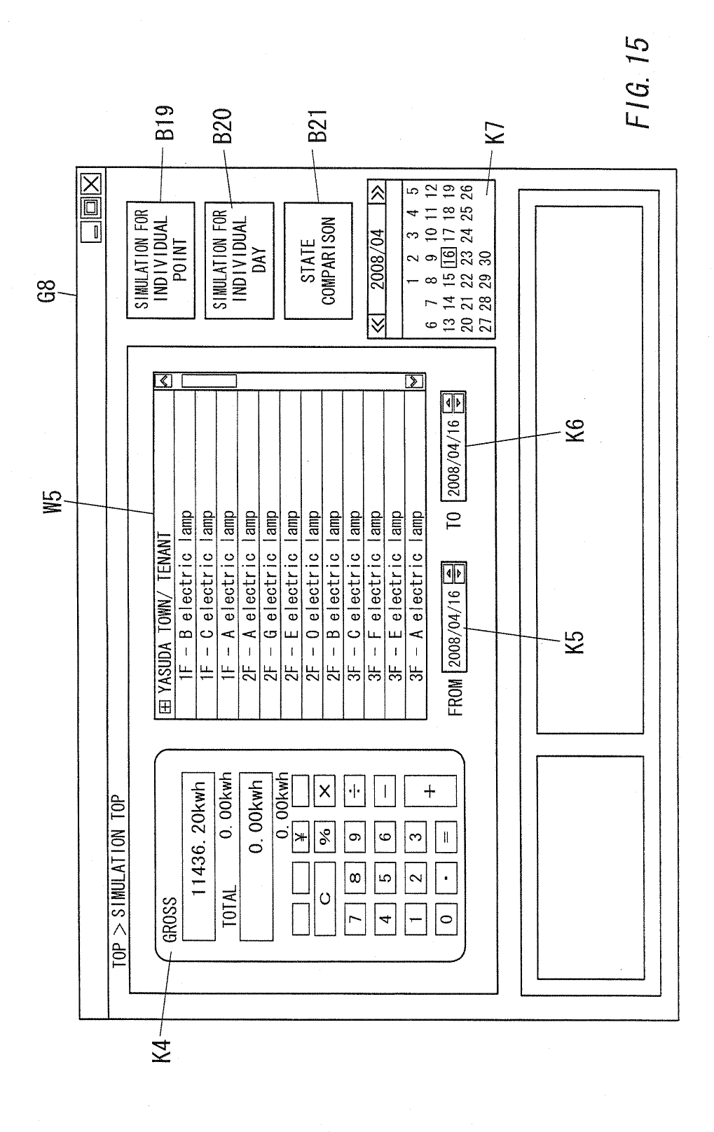

Next, the calculation unit 14 controls the indication unit 12 to display a top screen G8 of a simulation shown in FIG. 15.

The top screen G8 shows a calculator block K4 on a left part thereof, and a window W5 displaying a list of the measurement points on a center part thereof. The top screen G8 shows date blocks K5 and K6 on a lower central part thereof. The top screen G8 shows a calendar area K7 on a lower right part thereof. The top screen G8 shows the buttons B19 to B21 for selecting a type of a simulation on a left part thereof.

The calculator block K4 is used for indicating a simulation result. For example, the calculator block K4 shows numerically power consumption which is estimated to be wasteful when the common rule selected in the simulation is applied to the stored data of power consumption (the measurement value stored in the measurement value storing means 102).

The window W5 shows the list of the measurement points. The window W5 displays the registered measurement point in a list format. Besides, when a group is preliminarily determined when importing the data of power consumption, the measurement points are displayed hierarchically for each group. In addition, the measurement point can be displayed with a color corresponding to a type (e.g., PI and AI) thereof. With this arrangement, a user can easily know whether the measurement point is available for the desired simulation.

The date block K5 shows a start date of the simulation.

The date block K6 shows an end date of the simulation.

The calendar area K7 shows a calendar. The calendar area K7 displays a date having a corresponding data of power consumption and a date having no corresponding data of power consumption in a distinctive manner. For example, in the calendar area K7, a date having no corresponding data of power consumption is displayed with an underline, and a date having a corresponding data of power consumption is displayed without an underline. With this instance, it is possible to prevent a date having no corresponding data of power consumption from being selected as a simulation period.

The buttons B19 to B21 are respectively corresponding to “SIMULATION FOR INDIVIDUAL POINT”, “SIMULATION FOR INDIVIDUAL DATE”, and “STATE COMPARISON”. The simulation for an individual point is defined as a simulation which concerns a single measurement point and judges whether or not there is a time division in which the use of the device is judged wasteful due to forget of turning off the device.

Next, a measurement point to be used for the simulation is selected from the measurement points displayed on the window W5 (step S11).

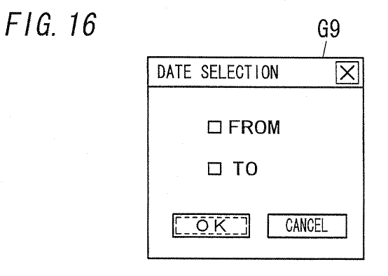

Subsequently, the simulation period is input (step S12). When the calendar area K7 is selected, the calculation unit 14 controls the indication unit 12 to display a pop-up screen G9 shown in FIG. 16. With the pop-up screen G9, it is possible to perform operation of selecting the start date and the end date of the simulation period. The start date selected in the pop-up screen G9 is displayed on the date block K5, and the end date selected in the pop-up screen G9 is displayed on the date block K6.

When the button B19 is selected in the top screen GB, the calculation unit 14 controls the indication unit 12 to display a simulation screen G10 for an individual point shown in FIG. 17 (step S13).

The simulation screen G10 displays periods of time by use of rectangular cells arranged in a 7 by 24 matrix manner. The vertically arranged cells indicate dates (days of the week), and the laterally arranged cells indicate time (0:00 to 24:00). In addition, the simulation screen G10 displays a time period (cell) to which the common rule is applied with emphasis of surrounding the time period by frames FL1 and FL2 of bold lines.

In the simulation screen G10, the usage information indicating means 105 indicates whether or not the electric device was used per unit time, and the evaluation indicating means 116 indicates whether use of the electric device is reasonable or wasteful per unit time.

In the instance shown in FIG. 17, it is made to display the unit times (time divisions) respectively with different colors, the unit times including one in which use of the electric device is determined reasonable, another in which use of the electric device is determined wasteful, and the other in which the electric device was not used. Since FIG. 17 is prepared in monochrome representation, it is made for the purpose of distinction, to indicate the unit times in which use of the electric device is determined to be reasonable and wasteful, respectively with the cells of different fill patterns. Namely the unit time in which use of the electric device is determined to be reasonable is illustrated with right-upper diagonal lines, and the unit time in which use of the electric device is determined to be wasteful is illustrated with cross-hatching.

Further, the simulation screen G10 displays indication blocks K8 and K9 on upper part thereof. The indication block K8 displays the simulation period. The indication block K9 displays the name of the measurement point. With looking at the indication blocks K8 and K9, it is possible to confirm contents of the parameters which were selected in the preceding screen (top screen G8) easily.

In addition, the simulation screen G10 displays a red icon I1, a yellow-green icon I2, and a yellow icon I3 below the indication blocks K8 and K9. The icons I1 to I3 are arranged in this order from left to right. It is noted in this connection that the FIG. 17 is prepared in monochrome representation, in which different hatching patterns are used for the purpose of consistency to indicate difference in color among the icons I1 to I3. In brief, the red icon I1 is illustrated with cross-hatching, and the yellow-green icon I2 is illustrated with right lower diagonal lines, and the yellow icon I3 is illustrated with right upper diagonal lines.

The icon I1 indicates a display color (display pattern) of time division in which use of the electric device is determined to be wasteful. The simulation screen G10 displays a total (1 kWh, in the illustrated instance) of power consumption corresponding to the icon I1 on the right side of the icon I1. The icon I2 indicates a display color (display pattern) of time division in which use of the electric device is reevaluated to be reasonable in conformity with the exception rule once after being determined to be wasteful. The simulation screen G10 displays a total (0 kWh, in the illustrated instance) of power consumption corresponding to the icon I2 on the right side of the icon I2. The icon I3 indicates a display color (display pattern) of time division to which the common rule (time zone) is not applied, and in which the electric device was used. The simulation screen G10 displays a total (126 kWh, in the illustrated instance) of power consumption corresponding to the icon I3 on the right side of the icon I3. Besides, a unit of power consumption is not limited to kilowatt-hour (kWh), and may be selected from one of British thermal unit (Btu) and megajoule (MJ). Further, an amount of CO₂ emission may be displayed instead of power consumption.

In the simulation screen G10, since whether or not the electric device was used in each unit time (time division) is indicated by use of colors, it is easy to understand what it displays. Moreover, in the simulation screen G10, in addition to display of whether or not the electric device was used in each unit time (time division), power consumption at the measurement point (electric device) is displayed numerically. Therefore, a user can know, in more detail, power consumption of the electric device in accordance with the schedule information.

The simulation screen G10 displays three selection button B22 to B24 on an upper right part thereof. The three selection buttons B22 to B24 are arranged in this order from left to right. The selection button B22 is a schedule incorporating button for displaying the current schedule information of the control terminals 5A and 5B on the simulation screen G10, and for incorporating contents of the schedule information input into the terminal device 10A into contents of the schedule information stored in the configuration storing means 51A and 51B of the corresponding control devices 5A and 5B. The selection button B23 is a simulation executing button. When the selection button B23 is selected, the calculation unit 14 calculates an amount of power consumption in a situation where a simulation result is applied to all the registered measurement points rather than the simulated measurement point. The calculation unit 14 displays a result obtained by recalculation on the simulation screen G10 being a preceding screen. The selection button B24 is a rule save button for saving a result obtained by performing the simulation. When the selection button B24 is selected, the calculation unit 14 saves rules used for the simulation in a file, a database, or the like.

The simulation screen G10 shown in FIG. 17 indicates a result of the simulation based on power consumption measured at the measurement point of 6 F_air-conditioner_power in a week from March 1 (Sat) to March 7 (Fri).

The judging means 103 compares power consumption per time imported from the measurement point with the predetermined threshold (corresponding to the standby power consumption). The usage information indicating means 105 colors only a cell corresponding to a time period in which power consumption exceeds the predetermined threshold (i.e., a time period in which the electric device connected to the branch circuit operates), and displays the colored cells on the simulation screen G10. Besides, the usage information indicating means 105 hides a cell (e.g., paints the cell with a background color or white) corresponding to a time period in which power consumption does not exceed the predetermined threshold (i.e., a time period in which the electric device is kept turned off), thereby showing the cell corresponding to the time period in which power consumption does not exceed the predetermined threshold and the cell corresponding to the time period in which power consumption exceeds the predetermined threshold in a distinctive manner.

In addition, the time periods surrounded by the frames FL1 and FL2 in the simulation screen G10 indicate the time zones TZ1 and TZ2 of the common rule applied to the measurement point, respectively. With regard to the time zone TZ1, the days of the week are Monday to Friday, and the time is AM 0:00 to AM 6:00. With regard to the time zone TZ2, the days of the week are Monday to Friday, and the time is PM 10:00 to PM 12:00 (AM 0:00).

Notably, in the simulation screen G10, a display color pattern of a cell is selected in accordance with whether or not the cell is associated with the common rule. In this situation, the cell which is not associated with the common rule is displayed by the usage information indicating means 105. As a result, the cell which is not associated with the common rule and in which the electric device is determined to be used is displayed with the same color (hatching pattern) as the icon I3. The cell which is associated with the common rule is displayed by the evaluation indicating means 116. As a result, the cell which is associated with the common rule and in which use of the electric device is determined to be wasteful is displayed with the same color (hatching pattern) as the icon I1. In contrast, a cell which is associated with the common rule and in which use of the electric device is determined to be reasonable is displayed with the same color (hatching pattern) as the icon I2.

According to the time zones TZ1 and TZ2 shown in FIG. 17, power consumed from 22:00 to 23:00 on March 7 (Fri) is determined to be wasteful.

With reference to a usage condition of the electric device, in many cases, the electric device is used after the working hours (e.g., after 17:00). Therefore, it is assumed that a user may change the beginning of the time zone TZ2 from 22:00 to 21:00 in order to increase the level of monitoring of forgetting of turning off the device in nighttime (step S14). Besides, the time zone TZ2 can be changed by moving a left part of the frame FL indicative of the beginning time of the time zone TZ2 by means of drag of a mouse, for example.

When the time zone TZ2 is modified, the evaluating means 114 evaluates, by use of the above judgment logic A, whether or not use of the electric device is reasonable, regarding the modified time zone TZ2 (step S15). Thereafter, the evaluation indicating means 116 displays the evaluation result obtained by the evaluating means 114 (step S16).

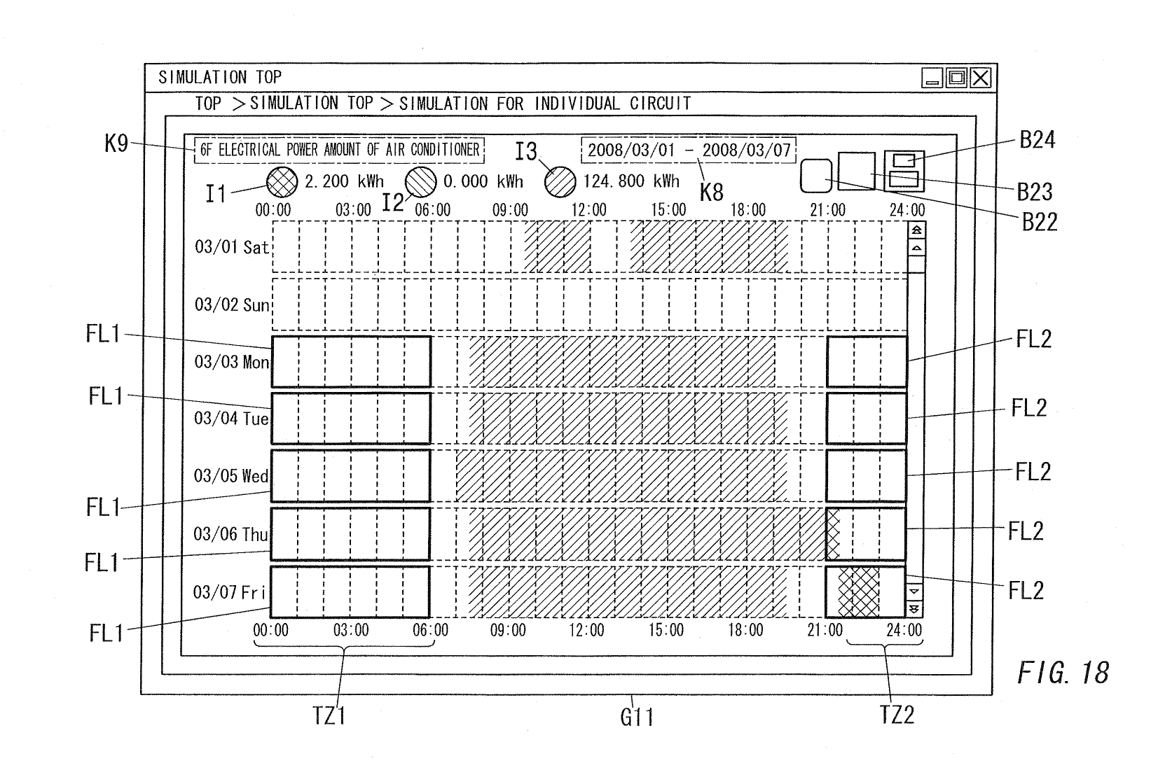

A simulation screen G11 shown in FIG. 18 displays a result of evaluation of whether or not use of the electric device is wasteful regarding the modified time zone TZ.

With this evaluation result, the periods of time in which use of the electric device is determined to be wasteful (21:00 to 21:30 on Thursday, and 21:30 to 23:00 on Friday) are increased. Therefore, power consumption corresponding to the icon I3 is decreased from 126 kWh down to 124.8 kWh while power consumption corresponding to the icon I1 is increased from 1 kWh up to 2.2 kWh.

Thereafter, the evaluating device judges, on the basis of an operation input from the input unit 11, whether or not it executes evaluation of whether or not use of the electric device is wasteful (step S17). For example, processing is returned to step S11 when the measurement point is changed, and processing is returned to step S13 when the time zone is changed. Thus, the evaluation of whether or not use of the electric device is wasteful is performed on the basis of the measurement point or time zone after being changed.

In addition, when a predetermined manipulation (e.g., manipulation of clicking the right mouse button to select the frame FL2 of the time zone TZ2) is performed in a situation of displaying the simulation screen G10 shown in FIG. 17, the calculation unit 14 controls the indication unit 12 to pop up a screen (not shown) for displaying an operation menu. The screen for displaying the operation menu shows an operation button for modifying the time zone.

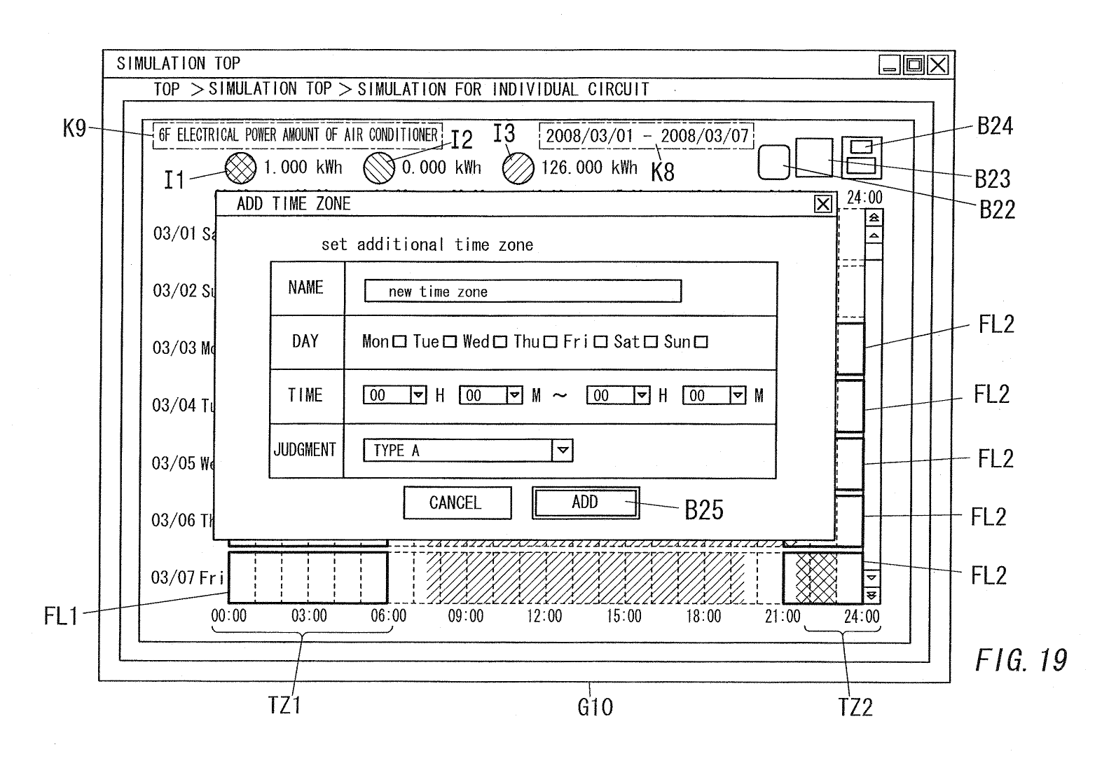

When the above operation button for modifying the time zone is selected, the calculation unit 14 controls the indication unit 12 to display a time zone modification screen G12 as shown in FIG. 19.

The time zone modification screen G12 is defined as a screen for modifying the name, the days of the week, the time, and the judgment logic of the time zone. The time zone modification screen G12 receives modifications of the name, the days of the week, the time, and the judgment logic of the time zone. Input of the name, the days of the week, the time, and the judgment logic of the modified time zone is made by use of the input unit 11. In addition, the time zone modification screen G12 displays a modification button B25. When the modification button B25 is selected, the calculation unit 14 modifies the time zone on the basis of the name, the days of the week, the time of the day, and the judgment logic input in the time zone modification screen G12, and stores the modified time zone in the storage unit 13. Moreover, the evaluating means 114 evaluates whether or not use of the electric device is wasteful, with regard to the modified time zone.

Besides, the simulation screen G10 is preferred to change colors of the frames FL1 and FL2 in accordance with the type of the judgment logic (the judgment logic A, B, or C). In this arrangement, a user can immediately know which judgment logic is applied to the time zone, simply by looking at the screen. Therefore, it is possible to prevent occurrence of miss configuration and to improve operability. Besides, instead of the colors of the frames FL1 and FL2, a type (solid line, dashed line, or broken line) or a width of lines of the frames FL1 and FL2 may be changed in conformity with the type of the judgment logic.

The simulation screen G10 shown in FIG. 17 shows a result obtained by applying the judgment logic A to the two time zones TZ1 and TZ2.

Now, it is assumed that the judgment logic B is applied to the time zone TZ2 instead of the judgment logic A.

In the judgment logic B, it is judged whether or not power consumption in unit time at the end of the time zone (latest unit time) exceeds the predetermined threshold. When power consumption exceeds the predetermined threshold, the evaluating means 114 searches from the end of the time zone to the beginning of the time zone for unit time (excess part) in which power consumption exceeds the predetermined threshold. The evaluating means 114 considers successive excess part as a single time period, and determines that use of the electric device in the single time period is wasteful. When the evaluating means 114 detects unit time in which power consumption does not exceed the predetermined threshold (when succession of the excess part is interrupted), the evaluating means 114 regards the excess part prior to the detected unit time as the undefined part about which the evaluating means 114 can not judge whether use of the electric device is reasonable or wasteful (e.g., the excessive time prior to the detected unit time is displayed with green). In addition, when power consumption in unit time at the end of the time zone does not exceed the predetermined threshold, the evaluating means 114 considers each unit time included in the time zone as the undefined part about which the evaluating means 114 can not judge whether use of the electric device is reasonable or wasteful (e.g., the all unit time included in the time zone is displayed with green).

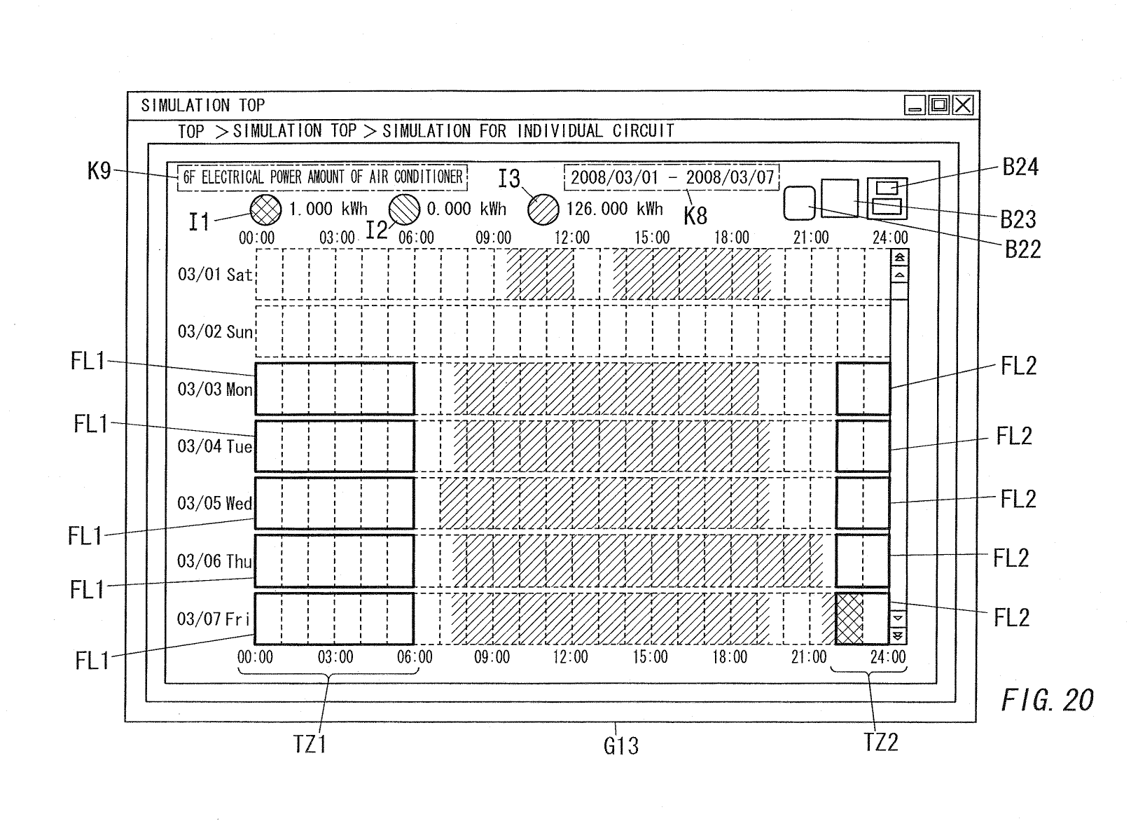

As described in the above, with the judgment logic B, the evaluating means 114 determines that the using period including the end of the time zone is a period in which use of the electric device is wasteful and that the other using period is the undefined part about which the evaluating means 114 can not judge whether or not use of the electric device is wasteful. Therefore, when the judgment logic B is selected, the cell which would be displayed with the same color as the icon I1 in the case of the simulation screen G13 shown in FIG. 20 is displayed with a color (e.g., green) indicative of the undefined part about which the evaluating means 114 can not judge whether use of the electric device is reasonable or wasteful. The aforementioned judgment logic B is preferred to be applied to the time zone including 24:00 (midnight).

Alternatively, it is assumed that the judgment logic C is applied to the time zone TZ1 instead of the judgment logic A. As described in the above, with the judgment logic C, the evaluating means 114 determines that the using period including the beginning of the time zone is a period in which use of the electric device is wasteful and that the other using period is the undefined part about which the evaluating means 114 can not judge whether or not use of the electric device is wasteful. The aforementioned judgment logic C is preferred to be applied to the early-morning time zone such as a time zone including 0:00.

In the above instance, the early-morning time zone TZ1 is discriminated from the night-time time zone TZ2 with reference to 24:00 (0:00). Namely, the time zones are defined on a basis of 24:00 (0:00). However, the time zones may be defined on the basis of an opening hour, a closing hour, sunrise, sunset, or the like. In this instance, the energy management system is preferred to cooperate with the other system, or to automatically obtain sunrise and/or sunset. With this arrangement, even if the basis of the time zone is changed, a user need not adjust time of the time zone. Therefore, it is possible to improve usability.

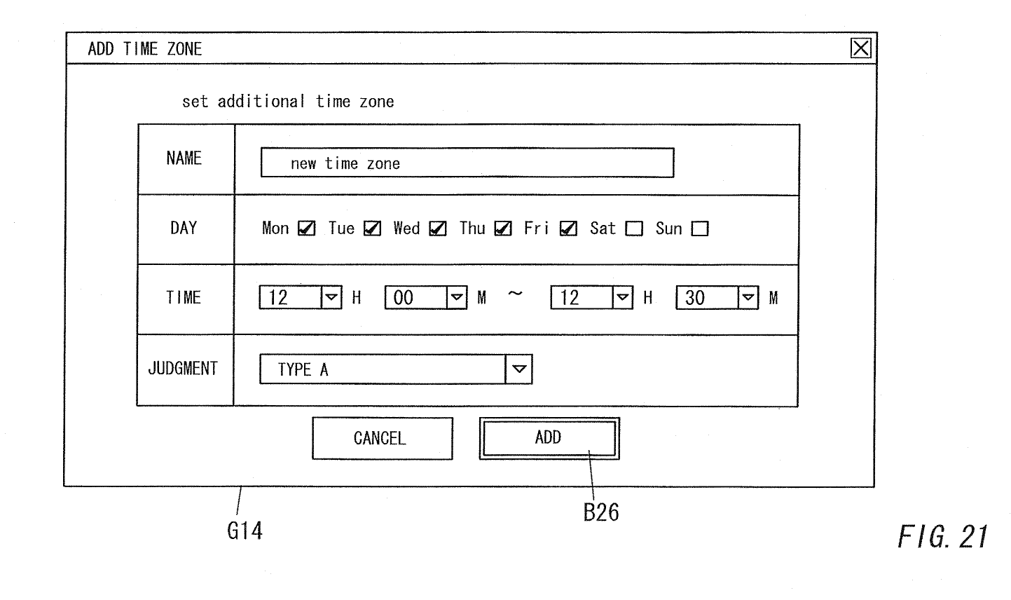

In addition, when a predetermined manipulation (e.g., manipulation of clicking the right mouse button to select a part other than the frames FL1 and FL2) is performed in a situation of displaying the simulation screen G10 shown in FIG. 17, the calculation unit 14 controls the indication unit 12 to a time zone addition screen G14 as shown in FIG. 21.

The time zone addition screen G14 is defined as a screen for adding a time zone. The time zone addition screen G14 receives the name, the days of the week, the time, and the judgment logic of the time zone to be added. The name, the days of the week, the time, and the judgment logic of the time zone to be added can be input via the input unit 11. In addition, the time zone addition screen G14 displays an addition button B26. When the addition button B26 is selected, the calculation unit 14 creates a new time zone on the basis of the name, the days of the week, the time of the day, and the judgment logic input in the time zone addition screen G14, and stores the created time zone in the storage unit 13.

For example, in the instance of adding a time zone to lunch break on weekday, a user manipulates the input unit 11 to display the time zone addition screen G14. In the time zone addition screen G14, the user operates the input unit 11 to input “lunch break of weekday” for the name, “Monday to Friday” for the days of the week, “12:00 to 12:30” for the time, and “judgment logic A” for the judgment logic with respect to the time zone to be added, for example, and finally selects the addition button B26.

In this situation, the schedule input means 106 creates a new time zone TZ3 on the basis of conditions input in the time zone addition screen G14. Information in accordance with the time zone TZ3 is stored in the schedule storing means 107. Thereafter, the simulating means 108 recalculates the numerical values respectively displayed on the right sides of the icons 11 to 13 in conformity with the time zone TZ3.

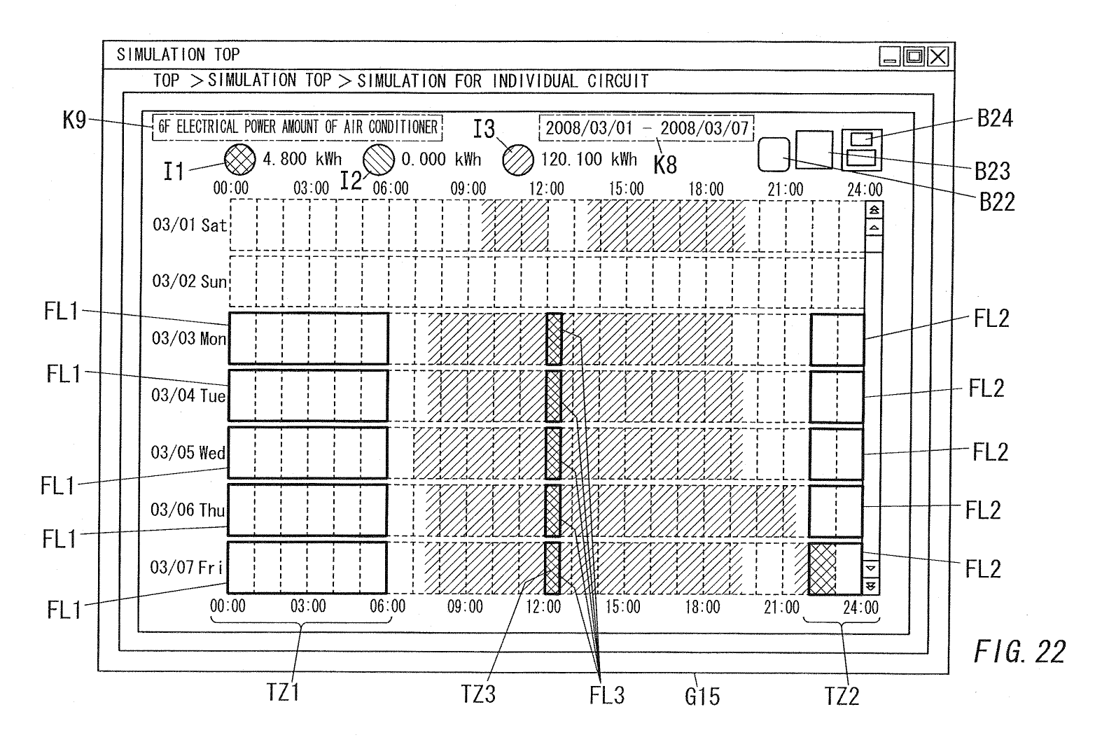

In addition; the evaluating means 114 evaluates whether use of the device is reasonable or wasteful with regard to the newly added time zone TZ3. In this instance, power consumption in periods of time from 12:00 to 12:30, on Monday to Friday exceeds the predetermined threshold. Therefore, the evaluating means 114 determines that use of the device in periods of time from 12:00 to 12:30, on Monday to Friday is wasteful. As a result, as shown in FIG. 22, the evaluation indicating means 116 displays frames FL3 indicative of the newly added time zone TZ3 on the simulation screen G15, and displays the cells corresponding to the frame FL3 with red.

As described in the above, a user can determine optimal schedule information by performing modification and/or addition of the time zone followed by performing simulation.

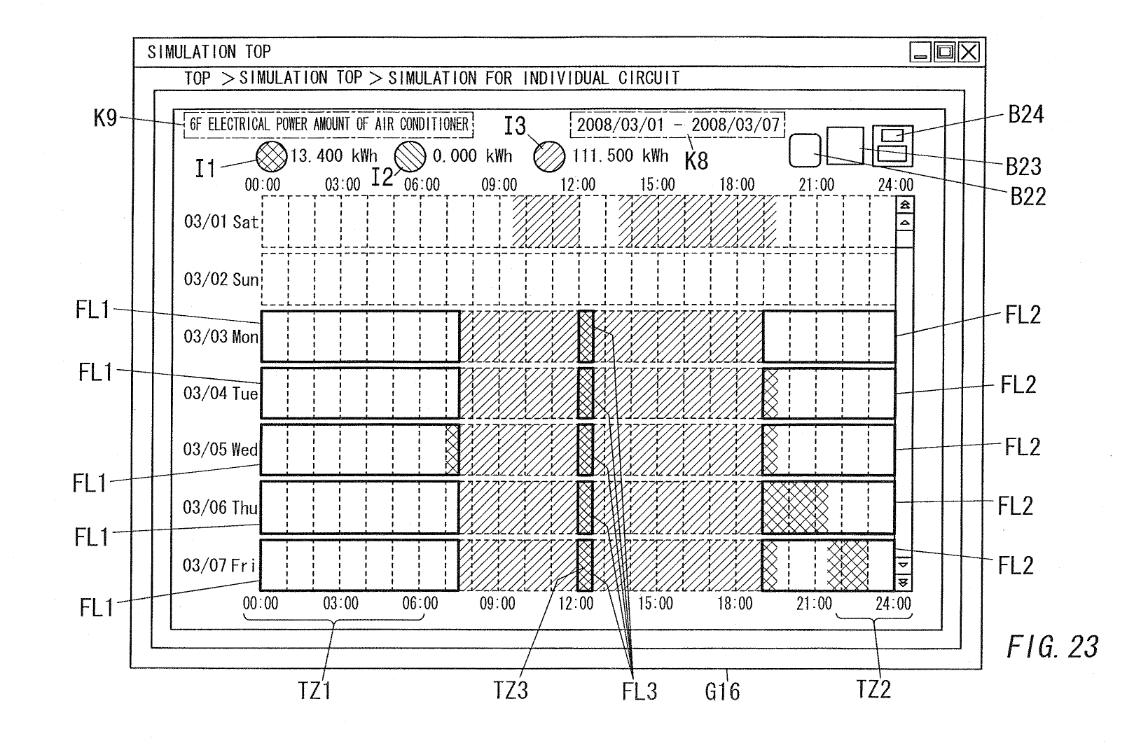

In the simulation screen G16 shown in FIG. 23, the time zone TZ1 is modified to have the periods of time from 0:00 to 7:30, on Monday to Friday, and the time zone TZ2 is modified to have the periods of time from 19:00 to 24:00, on Monday to Friday.

When the schedule incorporating button B22 is selected in the simulation screen G16 shown in FIG. 23, the calculation unit 14 controls the indication unit 12 to display the schedule information imported from the control devices 5A and 5B (schedule information stored in the configuration storing units of the control devices 5A and 5B), as shown in FIG. 24.

In the simulation screen G17 shown in FIG. 24, periods of time in which the device operates are indicated by a frame FL4. The previous schedule information determines that the device is turned on at 7:30 and is turned off at 19:00.

In a situation where the current schedule information of the control devices 5A and 5B is displayed (i.e., the simulation screen G17 shown in FIG. 24), when the schedule incorporating button B22 is selected, the calculation unit 14 controls the indication unit 12 to display the schedule information stored in the schedule storing means 107, as shown in FIG. 25.

In a simulation screen G18 shown in FIG. 25, time periods in which the device operates are indicated by frames FL5 and FL6. The newly added schedule information defines that the device is turned on at 7:30 and then turned off at 12:00 and turned on again at 12:30 and finally turned off at 19:00.

In the aforementioned instance, since the time zone TZ3 is included in the frame FL4, the periods of time corresponding to the time zone TZ3 are excluded from the frame FL4.

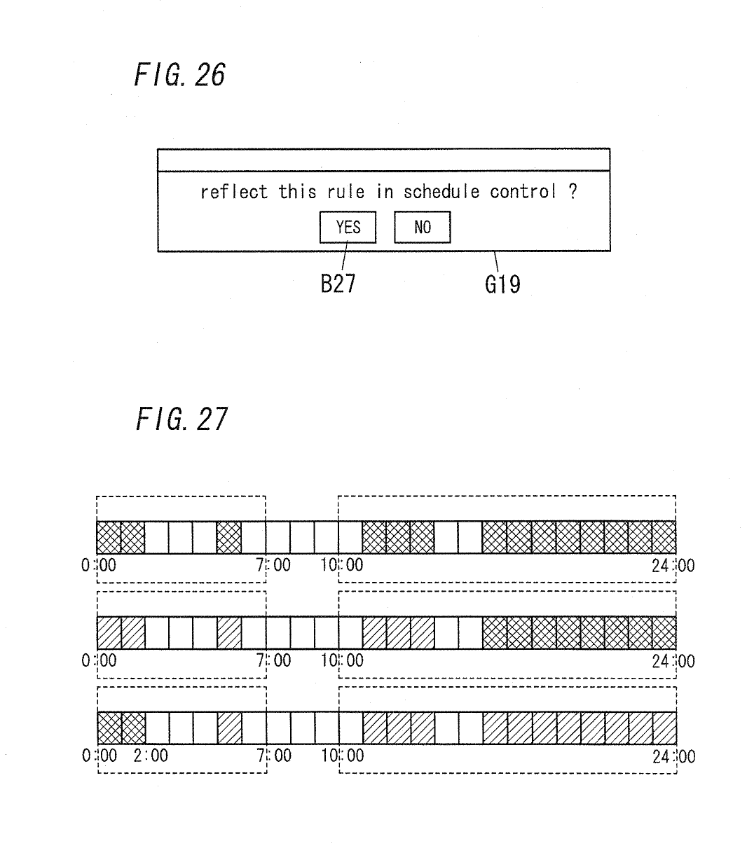

In a situation where the schedule information stored in the schedule storing means 107 is displayed (i.e., at the simulation screen G18 of FIG. 25), selection of the schedule incorporating button B22 causes the determining means 117 to display a pop-up screen G19, as shown in FIG. 26, which, in turn, queries whether or not the schedule information of the control devices 5A and 5B is modified (asking whether or not the current settings are reflected in the schedule control).

In the pop-up screen G19, when a button B27 corresponding to “yes” is selected (i.e., when modification of the schedule information stored in the configuration storing means 51A and 51B is decided by use of the determining means 117), the schedule sending means 121 sends only the modified schedule information to the control devices 5A and 5B with reference to the check result stored in the check storing means 120.

As described in the above, the terminal device 1A controls the communication unit 15 to transmit the newly created schedule information to the control devices 5A and 5B. Upon receiving the schedule information from the terminal device 1A, the control devices 5A and 5B update contents of the schedule information stored in the configuration storing means 51A and 51B to contents of the received schedule information (step S18).

In addition, when the rule save button B24 is selected, the calculation unit 14 saves the result obtained by the simulation (e.g., rules) in a file, a database, or the like (step S19).

As explained in the above, the energy management system of the present embodiment provides the terminal device 1A with the indication unit 12 which indicates, per each unit time, whether or not power was consumed (whether or not the device was used) in the predetermined time period. Also, the system allows the user to input the schedule information while watching the usage condition of the device. Further, the system provides the simulating means 108 which predicts, on the basis of power consumption (i.e., an amount of power actually consumed by the device) received by the power consumption receiving means 101, power consumption obtained when the device operates in accordance with the input schedule information. Therefore, it is easy for the user to acknowledge the power saving effect caused by modification of the schedule information. It is easy to create the schedule information which is practical and improves energy saving effect, in conformity with usage pattern of the device. Further, the energy management system of the present embodiment judges, for each unit time, on the basis of power consumption and the schedule information of the device, whether use of the device is reasonable or wasteful, and indicates the result obtained by the judgment. Therefore, the user can easily know whether use of the device is reasonable or wasteful, and can appropriately modify the schedule information. Moreover, the user can incorporate modification of the schedule information into the control devices 5A and 5B.

In the present embodiment, the judging means 103 judges whether or not the device was used. Alternatively, the energy management system may be configured to obtain history information which indicates operation time of the device from the control devices 5A and 5B. With this arrangement, it is possible to judge, on the basis of the history information obtained from the control devices 5A and 5B, whether the individual device is turned on or off. Therefore, judgment of whether or not use is reasonable can be made for each device.

Besides, in the present embodiment, the energy management program is installed in the terminal devices 1A and 1B, thereby controlling the terminal devices 1A and 1B to function as at least the power consumption receiving means 101, the measurement value storing means 102, the judging means 103, the judgment storing means 104, the usage information indicating means 105, the schedule input means 106, the schedule storing means 107, the simulating means 108, the prediction value storing means 109, and the prediction value indicating means 110. The aforementioned energy management system may be installed in the monitoring device 2.

Besides, the energy management system of the present embodiment may be configured to manage power consumption of the monitored device in a building such as a supermarket, a business place, and a residence. Moreover, the monitored device may be an electric device (e.g., a personal computer, a printer, a copier, an air purification device, and a ventilator) other than a lighting fixture and an air conditioner.

In brief, the aforementioned energy management system selects electricity as energy resources consumed by the device, and manages an amount of power consumed by the device (power consumption). However, the monitored device may be a device which consumes fluidic energy resources such as water and gas.

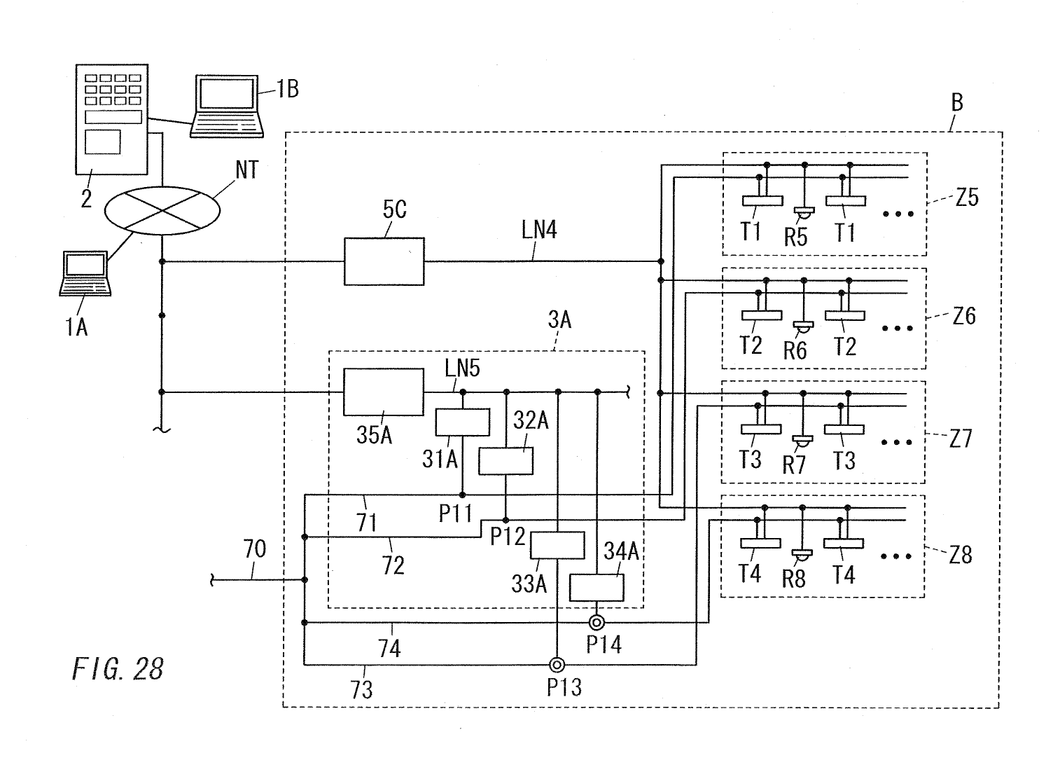

FIG. 28 shows a partially omitted schematic diagram illustrating a modification of the energy management system of the present embodiment.

The building B shown in FIG. 28 has zones Z5 to Z7 corresponding to restrooms of the first floor, and a zone Z8 corresponding to a restroom of the second floor. Plurality of flush toilets T1 to T4 using water is installed in the zones Z5 to Z8, respectively. Human sensors R5 to R8 configured to detect human presence in the corresponding zones Z5 to Z8 are installed in the zones Z5 to Z8, respectively.

There are a main pipe 70 and four branch pipes 71 to 74 installed in the building B. The four branch pipes 71 to 74 diverge from the main pipe 70. These pipes 70 to 74 are water pipes. The branch pipes 71 to 74 are used for supplying water to the toilets T1 to T4, respectively. In addition, the branch pipes 71 to 74 are provided with measurement points P11 to P14 for measurement of flow, respectively. Besides, in the instance shown in FIG. 28, the toilets T1 to T4 are exemplified as devices. However, the device may be a water heater or a water outlet. Further, the device may be a remotely controllable water shutoff valve. In this instance, it is possible to prevent wasteful water consumption caused when a user forgets turning off the water outlet or does not turn off the water outlet firmly.

The energy management system shown in FIG. 28 includes a measurement device 3A and a control device 5C in addition to the aforementioned terminal devices 1A and 1B, and the monitoring device 2.

The measurement device 3A is defined as a flow monitoring device configured to measure water usage in the toilets T1 to T4, and send the measured water usage to the monitoring device 2 and the terminal device 1A. The measurement device 3A includes flowmeters 31A to 34A installed inside of the building B and a collection device 35A. Each of the flowmeters 31A to 34A is connected to the collection device 35A by use of a signal line LN5. The flowmeters 31 to 34 measure a flow corresponding to the measurement points P11 to P14 at a predetermined measurement period, respectively.

Each of the flowmeters 31A to 34A acts as a measurement value obtaining means which is configured to obtain a measurement value indicative of an amount of water consumed by devices in the predetermined time period. Besides, flows of the branch pipes 71 to 74 are a total of flows of the plural toilets T1 to T4 belonging to the zones Z5 to Z8, respectively.

Each of the flowmeters 31A to 34A stores the collected measurement value in an incorporated memory (not shown) thereof. Each of the flowmeters 31A to 34A is configured to output the measurement value stored in the incorporated memory to the collection device 35A at a predetermined transmission period

The collection device 35A is configured to receive the measurement values output from the flowmeters 31A to 34A. The collection device 35A functions as a first storing means which is configured to store the measurement values received from the flowmeters 31A to 34A in association with date and time of measurement thereof. In addition, the collection device 35A is connected to the monitoring device 2 via the communication network NT. The collection device 35A is configured to transmit the measurement values of the branch pipes 71 to 74 to the monitoring device 2 in response to the request from the monitoring device 2 (e.g., upon receiving the aforementioned monitoring data request signal from the monitoring device 2).

The control device 5C is a toilet control device which is configured to control operation of the toilets T1 to T4. The control device 5C is configured to transmit/receive a transmission signal including address information to/from the transmission line LN4 to communicate with the desired one of the toilets T1 to T4 and the human sensors R5 to R8. The above control device 5C has the approximately same configurations as the control device 5A, and no detailed explanation thereof is deemed necessary.

Further, the storage units 13 of each of the terminal devices 1A and 1B shown in FIG. 28 store a program of managing water usage, of simulating water usage, and of evaluating whether or not use of the device is reasonable. Each of the terminal devices 1A and 1B executes this program, thereby realizing a function of managing water usage, a function of simulating water usage, and a function of evaluating whether or not use of the device is reasonable.

The terminal devices 1A and 1B operate in a similar manner as the terminal devices 1A and 1B make management of power consumption and the like. Therefore, no detailed explanation thereof is deemed necessary. Besides, the aforementioned human sensors R5 to R8 are employed for judgment of the above exception rule.

As described in the above, the energy management system in accordance with the present invention may be configured to manage an amount of energy resources used by devices. The energy resources are not limited to electricity and may be selected from water and gas. In other words, the energy management system in accordance with the present invention may be configured to manage water usage and gas usage in addition to power consumption. Further, the energy management system in accordance with the present invention may be configured to manage usage of at least one of energy resources (e.g., electricity, water, and gas).

In addition, according to the present embodiment, the control devices 5A to 5C store the schedule information for each device. In contrast, each device may store the schedule information thereof. In other words, each device may be configured to store the schedule information thereof, and is configured to operate in conformity with the stored schedule information. In this instance, the terminal device 1A may be configured to, when modified contents of the schedule information are determined, apply the modified schedule information to a device in which the schedule information is necessitated to be modified, on the basis of the modified contents of the schedule information input by use of the schedule input means 106. In brief, the terminal device IA may be used as a device configuration means which is configured to determine the schedule information for each device from a remote location.

1. An energy management system for managing a device comprising:
an obtaining means configured to obtain a measurement value indicative of an amount of measured energy resources used in the device in a predetermined time period;
a measurement value storing means configured to store said measurement value obtained by said obtaining means;
a judging means configured to judge whether or not the device was used for each unit time, on the basis of the measurement value stored in said measurement value storing means;
a judgment storing means configured to store a judgment result indicative of a result obtained by judgment of said judging means;
a usage information indicating means configured to indicate whether or not the device was used for each unit time, on the basis of the judgment result stored in said judgment storing means;
a schedule input means adapted in use to input schedule information which defines operation of the device for each unit time in the predetermined time period;
a schedule storing means configured to store the schedule information input by use of said schedule input means;
a simulating means configured to calculate a prediction value on the basis of the measurement value stored in said measurement value storing means, said prediction value being indicative of the energy resources used in the device which operates in accordance with the schedule information stored in said schedule storing means;
a prediction value storing means configured to store the prediction value calculated by said simulating means; and
a prediction information indicating means configured to indicate the prediction value stored in said prediction value storing means.

2. An energy management system as set forth in claim 1, wherein
said energy management system comprises:
an evaluating means configured to evaluate whether use of the device is reasonable or wasteful for each unit time, on the basis of the measurement value stored in said measurement value storing means and the schedule information stored in said schedule storing means;
an evaluation storing means configured to store an evaluation result indicative of a result obtained by evaluation of said evaluating means; and
an evaluation indicating means configured to indicate whether the use of the device is reasonable or wasteful for each unit time, on the basis of the evaluation result stored in said evaluation storing means.

3. An energy management system as set forth in claim 2, wherein
said evaluating means is configured to, when a variation with time of the measurement value stored in said measurement value storing means fulfills a prescribed condition, determine that the use of the device is wasteful.

4. An energy management system as set forth in claim 3, wherein
the prescribed condition is defined as a condition where a period in which the measurement value exceeds a predetermined threshold is kept over a predetermined time.

5. An energy management system as set forth in claim 2 wherein,
said energy management system comprises a device information storing means configured to store, for each device, a type of the device and a installation site indicative of a place in which the device is installed,
said evaluating means being configured to judge, on the basis of the type and the installation site for each device stored in said device information storing means, whether or not a plurality of the devices having different types exist on the same installation site, and said evaluating means being configured to, upon determining the plurality of the devices having different types exist on the same installation site, evaluate, on the basis of a combination of the type of each device and the judgment result, whether use of the device is reasonable or wasteful.

6. An energy management system as set forth in claim 2 wherein,
said evaluating means is configured to, when a particular time fulfils a predetermined exception condition, determine that use of the device in the particular time is reasonable, the particular time being defined as time in which it is determined that use of the device is wasteful.

7. An energy management system as set forth in claim 6 wherein,
said energy management system comprises an information storing means configured to store, for each device, an installation site indicative of a place in which the device is installed, and a human detecting means configured to detect human presence in the installation site, and
said exception condition being defined as a condition where said human detecting means has detected a human presence in the installation site of the device.

8. An energy management system as set forth in claim 8, wherein
said usage information indicating means is configured to indicate numerically the energy resources used in the device.

9. An energy management system as set forth in claim 1 wherein,
said energy management system comprises a control device configured to control the device, and a configuration device configured to communicate with said control device,
said control device comprising:
a configuration storing means configured to store the schedule information;
a device control means configured to control the device in conformity with the schedule information stored in said configuration storing means;
a schedule receiving means configured to receive the schedule information from said configuration device; and
a rescheduling means configured to change contents of the schedule information stored in said configuration storing means into contents of the schedule information received at said schedule receiving means, and
said configuration device comprising:
a determining means adapted in use to determine change of the schedule information stored in said configuration storing means of said control device;
a current schedule storing means configured to store the schedule information stored in said configuration storing means;
a checking means configured to check, on the basis of the schedule information stored in said schedule storing means and the schedule information stored in said current schedule storing means, whether or not the schedule information has been changed;
a check storing means configured to store a check result indicative of a result obtained by check of said checking means; and
a schedule sending means configured to, when the modification of the schedule information stored in said configuration storing means is determined by use of said determining means, send only modified schedule information to said control device with reference to the check result stored in said check storing means.

10. An energy management system as set forth in claim 1 wherein,
said energy management system comprises plural measurement devices, a monitoring device configured to communicate with said plural measurement devices respectively, and a terminal device configured to communicate with said monitoring device,
said terminal device comprising said obtaining means, said measurement value storing means, said judging means, said judgment storing means, said usage information indicating means, said schedule input means, said schedule information storing means, said simulating means, said prediction value storing means, and said prediction information indicating means,
each of said measurement devices comprising:
a measuring means configured to measure an amount of energy resources used in the device in the predetermined time period, thereby obtaining the measurement value; and
a first storing means configured to store the measurement value obtained by said measuring means,
said monitoring device comprising:
a measurement value obtaining means configured to retrieve the measurement value from said first storing means of each of said measurement device; and
a second storing means configured to store the measurement value retrieved by said measurement value obtaining means, and
said obtaining means being configured to acquire the measurement value from said second storing means of said monitoring device.

11. A program product used in an energy management system managing devices, and when a computer executes said program product, said computer functioning as:
an obtaining means configured to obtain a measurement value indicative of an amount of measured energy resources used in the device in a predetermined time period;
a measurement value storing means configured to store said measurement value obtained by said obtaining means;
a judging means configured to judge whether or not the device is used for each unit time, on the basis of the measurement value stored in said measurement value storing means;
a judgment storing means configured to store a judgment result indicative of a result obtained by judgment of said judging means;
a usage information indicating means configured to indicate whether or not the device is used for each unit time;
a schedule input means adapted in use to input schedule information which defines operation of the device for each unit time in the predetermined time period;
a schedule storing means configured to store the schedule information input by use of said schedule input means;
a simulating means configured to calculate a prediction value on the basis of the measurement value stored in said measurement value storing means, said prediction value indicative of the energy resources used in the device which operates in accordance with the schedule information stored in said schedule storing means;
a prediction value storing means configured to store the prediction value calculated by said simulating means; and
a prediction information indicating means configured to indicate the prediction value stored in said prediction value storing means.
